(19) United States
(12) Patent Application Publication
(10) Pub. No.: US 2008/0134043 A1
(43) Pub. Date: Jun. 5, 2008

(54) SYSTEM AND METHOD OF SELECTIVE MEDIA CONTENT ACCESS THROUGH A RECOMMEDNATION ENGINE

(75) Inventors: Nikolaos Georgis, San Diego, CA (US); Frank Li-De Lin, Pasadena, CA (US); Paul Hwang, Burbank, CA (US); Liang-Jye Chang, Poway, CA (US); Masashi Kuroko, Escondido, CA (US); Timothy Miller, San Diego, CA (US); Djung Nguyen, San Diego, CA (US); Jianyu Roy Zheng, San Diego, CA (US); Mark A. Hanson, San Jose, CA (US); Nicholas James Colsey, Del Mar, CA (US); Fredrik Carpio, SanDiego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION, Tokyo (JP); SONY ELECTRONICS, INC., Park Ridge, NJ (US)

(21) Appl. No.: 11/840,814

(22) Filed: Aug. 17, 2007

Related U.S. Application Data
(63) Continuation-in-part of application No. 11/600,579, filed on Nov. 16, 2006.
Application No. 11/600,579 is a continuation-in-part of application No. 11/602,566, filed on Nov. 21, 2006.
Application No. 11/602,566 is a continuation-in-part of application No. 11/711,259, filed on Feb. 27, 2007.
Application No. 11/711,259 is a continuation-in-part of application No. 11/715,803, filed on Mar. 8, 2007.
Application No. 11/715,803 is a continuation-in-part of application No. 11/699,908, filed on Jan. 30, 2007.
Application No. 11/699,908 is a continuation-in-part of application No. 11/726,956, filed on Mar. 23, 2007.
(60) Provisional application No. 60/838,811, filed on Aug. 18, 2006.
(60) Provisional application No. 60/809,093, filed on May 26, 2006.
(60) Provisional application No. 60/836,709, filed on Aug. 9, 2006.
(60) Provisional application No. 60/835,020, filed on Aug. 1, 2006.
(60) Provisional application No. 60/878,572, filed on Jan. 3, 2007.

(51) Int. Cl. G06F 3/00

(52) U.S. Cl. 715/733

(57) ABSTRACT

A personalized entertainment and information platform (Sphere) which provides personalized content delivery across different platforms and modes of delivery. A personal media device (e.g., PC, television, and so forth) interacts with a control server configured for accessing media content and metadata over the Internet. In response to input from the user and the history of user media selection and viewing, a prioritized recommendation list is generated and queued for downloading. The associated content is then downloaded automatically to the personal media device, without the need of user interaction. At this time the user can access the downloaded content immediately without a lengthy delay in waiting for content downloading. It will be appreciated that content such as shows and movies in HD format are of significant size (e.g., up to 50 GB) which would require significant download time, and tie up network and system resources.

### CROSS-REFERENCE TO RELATED APPLICATIONS

This application claims priority from U.S. provisional patent application Ser. No. 60/838,811 filed on Aug. 18, 2006, incorporated herein by reference in its entirety. This application is a continuation-in-part of U.S. patent application Ser. No. 11/600,579 filed on Nov. 16, 2006, incorporated herein by reference in its entirety, which claims priority from U.S. provisional patent application Ser. No. 60/809,093 filed on May 26, 2006, incorporated herein by reference in its entirety, and which claims priority from U.S. provisional patent application Ser. No. 60/836,709 filed on Aug. 9, 2006, incorporated herein by reference in its entirety. This application is a continuation-in-part of U.S. patent application Ser. No. 11/602,566 filed on Nov. 21, 2006, incorporated herein by reference in its entirety, which claims priority from U.S. provisional patent application Ser. No. 60/835,020 filed on Aug. 1, 2006, incorporated herein by reference in its entirety. This application is a continuation-in-part of U.S. patent application Ser. No. 11/711,259 filed on Feb. 27, 2007, incorporated herein by reference in its entirety. This application is a continuation-in-part of U.S. patent application Ser. No. 11/715,803 filed on Mar. 8, 2007, incorporated herein by reference in its entirety. This application is a continuation-in-part of U.S. patent application Ser. No. 11/699,908 filed on Jan. 30, 2007, incorporated herein by reference in its entirety. This application is a continuation-in-part of U.S. patent application Ser. No. 11/726,956 filed on Mar. 23, 2007, incorporated herein by reference in its entirety. This application claims priority from U.S. provisional application Ser. No. 60/878,572, filed on Jan. 3, 2007, incorporated herein by reference in its entirety. Priority is claimed to each of the foregoing applications.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to media content distribution, and more particularly to a personalized entertainment and information environment.

2. Description of Related Art

The market of internet-based music and video on-demand services are growing dramatically. It is expected that other internet-based contents/service businesses may also be subject to a similarly strong growth trend. Recently, integration and bandwidth considerations are becoming increasing important concerns differentiating services from one another across a plurality of platforms.

The delivery of video content over the Internet (e.g., using Internet Protocols (IP)) is generally accomplished either by streaming (the user watches the video as the bits arrive) or by downloading. Consumer broadband services in most areas of the world are unable to stream video at normal quality levels, wherein little hope exists for streaming high definition content in the foreseeable future. Therefore, companies delivering video content over the Internet for viewing on the television are delivering this content utilizing downloads. One problem with downloading is that it still requires a long period of time to download a show or movie, in particular if that content is in a high definition (HD) format.

To circumvent these limitations, downloads are typically made available at lower encoding rates and thus quality. Regardless of these drawbacks a number of entities make available content at less than DVD quality encoding rates. Even systems utilized by companies offering movies for rent or sale over the Internet are remarkably similar in that they offer lower quality content. It is interesting to note that a number of media distribution companies (MovieLink, CinemaNow, Starz, Comcast) provide remarkably similar offerings and utilize the same set of partners to deliver these capabilities.

The current market of these IP-based contents and/or service businesses can be generally categorized depending on the hardware platform, such as into web based content services or those distributed with hardware.

The category of web-based content service providers is considered mainstream for existing content service provider businesses in which the business is targeted on PC platforms. The fundamental business model in this category is based on the contents/service sale revenue with either “subscription” or “download to own”. A number of categories and companies are represented, including the following: (a) Video services (MovieLink, CinemaNow, Clickstar, AOL Video, Google Video, YouTube, etc.); (b) Music services (iTunes Music Store, Napster, Yahoo Music, etc.); (c) Photo services (Kodak, Ofoto, Shutterfly, etc.); (d) Communication services (Skype, Webex, Google Talk, etc.); (e) Community services (Myspace, Facebook, etc.); (f) On-line Storage.

The category of content service providers with hardware distribution are considered to have developed their own proprietary hardware platform to be connected directly to the TV, in which the user does not require a PC to receive their service. Services of this nature include Moviebeam, Akimbo, Netflix and TiVo. Each company initiates its own hardware-based content service business model from a different origin.

As media moves from standard definition (SD) to high definition (HD) the difficulty associated with distributing media content increases dramatically. For example, the time required for downloading shows or movies is dramatically increased. At the same time, the competition for the renting and sales of media has continued to intensify.

Accordingly, a need exists for methods and systems for profitably distributing high quality content across web and hardware categories. The present invention fulfills that need and others, and overcomes a number of drawbacks of previous systems.

### BRIEF SUMMARY OF THE INVENTION

The present invention describes a personalized entertainment and information platform that can provide personalized content delivery across different platforms and modes of delivery. For the sake of simplicity of description, and not limitation, the system and method is generally referred to herein under the name “Sphere”. Sphere provides digital delivery (e.g., through Internet Protocol (IP)) of digital content and services in a personalized environment. Cooperation is fostered with mainstream content/service providers to deliver additional end-user value and to optimize downstream revenue opportunity. The object of the Sphere system is to provide a comprehensive platform for the delivery of Internet based content and services to various media devices, allowing each individual device to deliver the best possible consumer experience.

The apparatus, system, and method described herein provides for factory downloading of content, monitoring of customer usage, and replenishment of recommended content at the lowest possible cost, such as through server-to-peer (e.g., content delivery network (CDN)) and peer-to-peer (P2P) mechanisms, off-peak data transfer, and other cost minimization techniques as desired. It should be appreciated that the term peer-to-peer (P2P) is utilized herein, unless otherwise specified, to mean operations including full peer-to-peer operation as well as peer-assisted operations. The system and method of the invention can be transparent to the user while it recommends content based on a number of different criteria. The content is determined, fully or at least in part, by an intelligent recommendation engine that determines which available content has the highest probability of relevance to the user, wherein it is economical to load this content (or at least excerpts of the content to entice acceptance of further downloading) in the background (e.g., trickle down) so as to recommend it to the users.

In one aspect of the invention, a sub-optimal recommendation method is utilized in which content that may be slightly less desirable to the user is downloaded in response to additional metrics, for example status of the network, availability of content on the content server, and/or peer-to-peer (P2P) content availability, and so forth. It will be appreciated that sub-optimal selection can also be considered an optimization process in which these other costing metrics are taken into account in a value/cost optimization.

Unlike other content or service aggregation portals, Sphere provides an immersive local experience, which is the result of the delivery of content and services (rather than re-direction of the user to content or service providers). As a result of the unique user interface, navigation capabilities, and delivery mechanism, users will enjoy a personalized entertainment experience that is much more like watching television than browsing and searching the Internet for media content. Consumers clearly enjoy the passive nature of a television viewing experience, while they appreciate the breadth of content available on the Internet. Sphere leverages advanced techniques and partner technologies to deliver Internet levels of content volume in a passive television viewing environment, while enabling active interaction when desired. Sphere answers the desire for having a truly immersive entertainment environment for enjoying volumes of entertainment and information as made available by the Internet. An object of the Sphere system is to create a software platform which works across all PC and non-PC computer devices, and can be integrated within a wide range of embedded devices (e.g., television sets, and so forth) to deliver mainstream entertainment content and Internet services. This platform leverages leading edge technology to deliver a personalized experience to each user, including a platform for the delivery of targeted advertising.

Sphere leverages Internet architecture to provide an open platform, enabling real-time addition of both content and service providers, so that content and services are available in a common fashion for any device. This enables Sphere to utilize a phased implementation to minimize risk and maximize flexibility.

Sphere is a comprehensive platform and not merely a content service. Sphere is configured to deliver a personalized experience of services and content to any hardware device across a myriad of usage scenarios. The Sphere platform may be installed, or more preferably pre-installed, on personal computers, (e.g., including laptops, electronic books, digital assistants, and so forth), as well as non-personal-computer hardware (e.g., set-top boxes, televisions, personal video recorders, digital video recorders, media centers, and so forth).

Sphere provides benefits over conventional video devices (e.g., DVD recorder-players, DVR-type devices), which are subject to a number of limitations. VCRs and DVRs are subject to long waiting times between the demand for the show and the time at which the show is available to watch, as well as the requirement for user interaction, in which the user must consciously select and enter channel and timing information to record a show, or select downloading of a show. Additional problems then stem from these shortcomings. For example, if the user wants to view shows that have been missed, or if they decide mid-season to watch/record prior shows in the sequence, then they would typically need to wait for a rerun of the series, which may or may not occur.

In addition, after content is selected, the process of transferring content (e.g., over the Internet) requires considerable downloading time for long media files and significantly more time to download high definition media, and/or multiple media files. Additionally, downloading a file at the fastest speed can saturate user bandwidth, adversely affecting the rest of the network activities, for instance slowing browsing, causing jitters to online gaming, and so forth.

Accordingly, the present invention recognizes the benefits of providing an automated mechanism for selecting content, such as shows and movies. The present invention also recognizes that additionally, or alternatively, it would be desirable to provide an optimized mechanism to make media data available for viewing by both predictive transfers and trickle down bandwidth usage.

User preference information is gathered directly from user input and/or activities and can be stored locally or centrally on a server outside of the home. Aspects of the present invention automatically (without user interaction) searches content libraries (e.g., of content providers) for content in response to a combination of user defined preferences and usage history, to determine content that has the highest probability of value to the user. This “recommended” content is then loaded onto local storage of the user without user interaction and made readily available for the user to enjoy when the user decides to enjoy it, without delay.

Accordingly, a method for providing content over a network for display on a home system includes the steps of generating a viewer profile associated with the home system, and based on the profile, predicting at least one piece of content in which a viewer of the home system is interested. The method also includes automatically sending that piece, or pieces, of content to the user at times when bandwidth is available, such as during a period of low bandwidth usage within the home system (e.g., at night). The content is sent to the user without the need of a specific request from the user (e.g., at their home system) to perform the download.

In one implementation, aspects of the viewer profile are based on detecting that one or more episodes of a series have been viewed, and determining the availability of additional episodes (e.g., earlier episodes, missed episodes, later episodes) of the series which are available on a server archiving episodes. One method of determining whether episodes have been “watched” is to determine if user viewing time for episodes of shows exceeds a threshold value, such as based on absolute time or content percentage. In general terms, the profile can be based on any combination of preferences received from the home system, user selection activity associated with the home system, and program metadata including title, genre, and broadcast time.

A collection of recommended programming is developed based on the profile and downloaded to a recommendation area of the home system for viewing thereof. In one aspect recommendations are first placed in a recommended content queue along with human-readable information prior to being downloaded to the user system. The content queue provides a mechanism within which the user may elect to preview recommendations prior to download commencement, wherein they may elect to cancel recommendations or change priority of download. Once downloading occurs, then a list of available recommended content is generated. The list may be displayed in response to user input, for example input on a remote control device, such as manipulation (i.e., a single push) of a single button on a remote controller for the home system. It will be appreciated, therefore, that according to this implementation, the user can access the recommendation queue for previewing, and the recommendation list for selecting recommended content which has already been downloaded to the system and from which selections can be made.

In another aspect, a method for delivering content to a home system communicating with a server and a peer-to-peer (P2P) network includes determining characteristics of the network associated with the home system, servers capable of serving desired content, and the availability of content elements in participating peers of that home system. The system utilizes the collected information to determine whether to provide a content file to the home system from a server or from the P2P network.

In another aspect, participating peers can be loaded up with entire pieces of content, or more preferably, loaded with segments of content to be served to other peers which agglomerate content from multiple peers into a whole.

An aspect of the invention is a personalized entertainment and information platform that can provide personalized content delivery across different platforms and modes of delivery.

Another aspect of the invention is a single registration process and agreement which opens up a pervasive environment to surround the user toward providing all content needs.

Another aspect of the invention is facilitating transaction processing between the system, third party vendors and the user.

Another aspect of the invention is to provide content services across numerous platforms, including operating from personal computer systems (or similar OS based platforms) or embedded systems (e.g., television sets, and so forth).

Another aspect of the invention is configured to interface with distribution partners to provide support or ancillary services.

Another aspect of the invention is to support advertising directed at the users of Sphere from various partners according to opt-in and characteristics established by the user and terms of service.

Another aspect of the invention is to support playback of advertising within content, or external to content, preferably in response to user selected advertising delivery parameters.

Another aspect of the invention is to provide for the preloading of content on various systems.

Another aspect of the invention configures build processes in which a set of media content is loaded onto computer-based electronic devices prior to shipment.

Another aspect of the invention is the segmentation and loading of different segments of content on different machines for delivery over the P2P network.

Another aspect of the invention involves the personalization of preloaded content, which also can provide a mechanism for initializing a recommendation engine.

Another aspect of the invention is a recommendation engine configured to identify at least one piece of content that has a high probability of being valuable to the user.

Another aspect of the invention is a data base of information utilized by the recommendation engine about available content, such as metadata, extracted information, ratings and information collected on viewing, information from other sources, and combinations thereof.

Another aspect of the invention is the collection of user preference information (viewer profiles) stored locally or on a server (e.g., central server), from which recommendations are directed.

Another aspect of the invention is identification of episodic viewing (e.g., episodes within a series), and associated generation of recommendations for content collection for the benefit of the user.

Another aspect of the invention is in establishing threshold conditions for identification of whether content is relevant, for example based on viewing time determining whether the show was viewed or is merely of some possible interest.

Another aspect of the invention is the identification of viewed content based on characteristics of that content (e.g., metadata, extended metadata, extracted characteristics).

Another aspect of the invention is generation of a profile into which user defined preferences are solicited and accepted.

Another aspect of the invention is a process of analyzing user content viewing and ordering activity.

Another aspect of the invention is the generation of recommendations tailored toward maximizing anticipated user value in relation to cost.

Another aspect of the invention is the generation of recommendations in response to various sized groups of individuals selected for each user to serve as templates or examples of content selection behavior.

Another aspect of the invention is that recommendations may be selected for downloading which are sub-optimal with respect to a user context, while providing benefit across a wider context range.

Another aspect of the invention provides optimization of recommendations with respect to one or more contexts, for example user context, distribution channel context, profitability context, and combinations thereof.

Another aspect of the invention is the generations of recommendations based on multiple decision points.

Another aspect of the invention is the generation of recommendations in two stages, a non-temporal stage (e.g., queuing) followed by a temporal stage (e.g., selecting content entry from queue).

Another aspect of the invention is the generation of recommendations in which a first stage queues up possible choices (e.g., non-temporal selection), which is followed by a second stage decision executed in response to server, network and/or P2P conditions at that time (e.g., temporal decision).

Another aspect of the invention is a simulator for determining pre-loading, content segmentation as seeds across the P2P, and sizing of segments.

Another aspect of the invention is the use of port hopping to increase the security of media files on the peers within the P2P network.

Another aspect of the invention is the ongoing generation of recommendations into a recommended content queue which directs the trickle-down distribution of the content.

Another aspect of the invention are records of the recommended content queue which contain both machine-readable information for use in controlling the download, and human-readable information to allow the user to preview recommendations, as desired, prior to downloading.

Another aspect of the invention is a recommended content queue preview interface, which allows the user to change recommendations, if desired, prior to the content being downloaded.

Another aspect of the invention is the generation of human-readable text explaining the reasoning behind recommendations that have been put forth, such as for inclusion within the human-readable portion of the recommended content queue and in the list of recommended content which has been downloaded.

Another aspect of the invention is the collection of recommendation feedback, such as collecting affirmative and negative response about the recommendation, which may specifically recite user reasoning.

Another aspect of the invention is controlling costs and latency factors during content distribution by the selection of whether to deliver a content element through servers, the P2P network, or a combination thereof.

Another aspect of the invention provides for user selection of disk space allotment for recommended content.

Another aspect of the invention is directed toward supporting any mainstream CODEC and DRM.

Another aspect of the invention is the automatic sending of content, or portions thereof, in response to recommendations generated from a recommendation engine.

Another aspect of the invention is the “trickle-down” distribution of content in a non-real-time manner, such as during periods of low bandwidth usage (e.g., such as at night).

Another aspect of the invention provides for the automatic downloading of music files, such as in response to user selected type (i.e., new in genre/category/artist), or recommendations.

Another aspect of the invention is the generation of incentives for participants supporting P2P content distribution.

Another aspect of the invention is the control of P2P support incentives comprising discounts or vouchers redeemable for selected content.

Another aspect of the invention is the generation of user alerts in response to fee requirements or conditions associated with the viewing of content downloaded on the basis of recommendation from the recommendation engine.

Another aspect of the invention is to provide a form of conditional viewing, wherein a viewer is granted a license to view one form of content if they will view another piece of content, such as another show, advertisement or similar.

Another aspect of the invention is to query user interests in recommended content by allowing the user to view all or portions of the content in a reduced quality format (e.g., limited resolution).

Another aspect of the invention is the gathering of specific feedback as to why recommendations are either of value to the user, or not of value to the user, toward enhancing recommendation accuracy for each given user.

Another aspect of the invention is a process for altering the form of content distribution, such as selection of servers, and/or P2P serving, (or even physical media) in response to user preferences, network conditions, utilization, and distribution cost factors.

Another aspect of the invention is the integration of physical content delivery, wherein the user need not leave Sphere for obtaining content in a physical form.

Another aspect of the invention is the facilitation of storage, management and use of content within the user device or system.

Another aspect of the invention is to provide for intelligent monitoring for replenishing and repositioning of recommended content.

Another aspect of the invention is the control of retention for recommended content configured for rental or sales level accessibility.

Another aspect of the invention is to intermediate transactions to purchase/rent content, such as accept payment, download additional material/license material, issue licenses, and so forth.

Another aspect of the invention performs automatic aggregation and synchronization of content (video, audio and images).

Another aspect of the invention performs playback of content from a library (i.e., music content) locally through any selected device (e.g., audio system, TV).

Another aspect of the invention facilitates the sharing of photos, making them accessible from any location.

Another aspect of the invention includes a user interface supporting a “2 foot” UI scenario (e.g., user at a PC or smart device) and a “10 foot” UI scenario (e.g., TV or similar).

Another aspect of the invention is the use of a free-space pointing device to facilitate creating an immersive experience within Sphere.

Another aspect of the invention displays information about recommended content, and parameters for controlling the recommendation engine.

Another aspect of the invention is configured to alert the user by displaying information about content which has been received and is ready for rental or sales, or for previewing prior to ordering.

Another aspect of the invention provides for displaying information about the recommended content queue, or recommended content which has already been downloaded, in response to the receipt of a remote control command.

Another aspect of the invention provides one or more remote control inputs (e.g., buttons) for viewing download status, selecting recommendation preferences, viewing and editing queued content recommendations, viewing downloaded recommendations, and for accepting recommended content (e.g., executing a transaction) to gain immediate access to that content.

A still further aspect of the invention provides cooperative integration of functionality with advertising partners and/or web partners.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a personalized content delivery system according to an aspect of the present invention.

FIG. 2 is a flowchart of content recommendations according to an aspect of the present invention.

FIG. 3 is a flowchart of content distribution according to an aspect of the present invention.

FIG. 4 is a block diagram of data flow for metadata and content within the Sphere system.

FIG. 5 is a flowchart of content recommendation according to an aspect of the present invention.

### DETAILED DESCRIPTION OF THE INVENTION

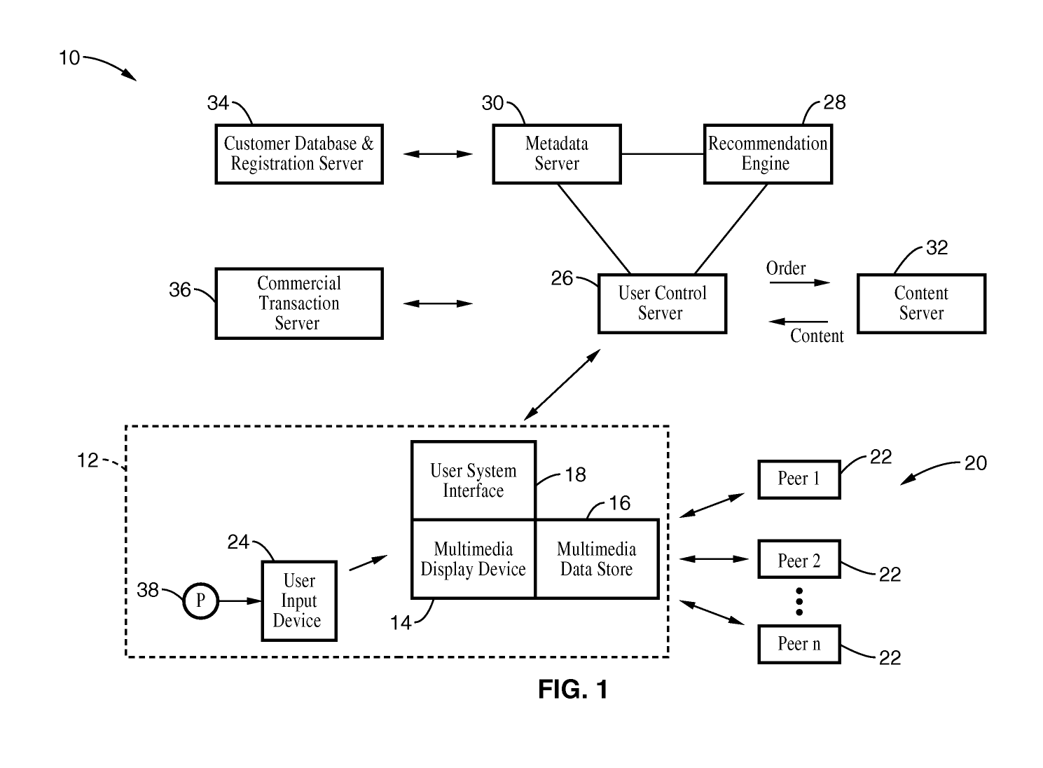

Referring more specifically to the drawings, for illustrative purposes the present invention is embodied in the apparatus generally shown in FIG. 1 through FIG. 5. It will be appreciated that the apparatus may vary as to configuration and as to details of the parts, and that the method may vary as to the specific steps and sequence, without departing from the basic concepts as disclosed herein.

1. Overview of System Block Diagram.

FIG. 1 illustrates a system, generally designated 10, that is intended to provide content in an intelligent way to a user home system 12. It will be appreciated that home system 12 is part of the overall system, referred to herein as Sphere, or the Sphere system. The system facilitates obtaining and viewing of content by users coupled to a distributed network, such as the Internet. Content is made available to users based on their preferences and viewing activity, wherein they may preview the content, buy or rent the content, and send recommendations for the content, with previews, to other users.

Home system 12 may include one or more multimedia display devices 14 such as televisions and/or computers, and one or more multimedia or content data stores 16, such as DVRs and disk players (e.g., digital video disk (DVD), Blu-ray (HD disk)), for supplying content for display on display device 14. A user system interface 18 can also be included in home system 12 as shown for receiving content from a server as described below or from a peer-to-peer (P2P) network 20 that includes multiple peers 22, (i.e., multiple home systems of other participating users).

It should be appreciated that the majority of Sphere functionality can be implemented as programming (e.g., software, firmware or a combination) which executes on computational elements within a user system, such as home system 12, and one or more Sphere user control servers located across the network. Computational elements can comprise any of a number of devices having means for executing programming, such as embedded controllers, microprocessors, general purpose (personal) computers, and other computer-based devices. Programming within the home system and the control servers cooperate with one another to execute the described functionality and integrate with additional elements over the network as described.

By way of example and not of limitation, user system interface 18 may be implemented within a set-top box (STB), or other media control device. In lieu of, or in addition to a STB, the user system interface 18 may also be implemented by an Internet connection device, such as a wired or wireless modem or other type of wide area network connection. Thus, communication between home system 12 and server/P2P systems described below may be through the Internet and/or TV cable and/or broadcast links, both terrestrial and satellite. Home system 12 may also include one or more user input devices 24 such as keyboards, mice, TV remote controllers, and so forth, to receive user input. A preference control 38 is shown coupled to input device 24 as an example of controlling content recommendations through the remote control device, as discussed at length in the user interface section.

As mentioned above, and as shown in FIG. 1, home system 12 can receive content from a server or server system, it shall be appreciated that server functionality described herein may be undertaken by a single server or multiple servers. In the non-limiting embodiment shown, a user control server 26 functions as a gateway for server communication with home system 12. The control server 26 communicates information from home system 12 to recommendation engine 28, which also receives program metadata information (e.g., format type, title, genre, playing time, keywords, and so forth) from a metadata server 30 to develop the below-discussed user profiles. Control server 26 also communicates with one or more content servers 32 to order content (e.g., such as archived TV series episodes) and receive the content in response to commands for content from home system 12 and in response to content that the user is predicted to desire based on information from recommendation engine 28 (also referred to as a personalization engine). Recommendation engine 28 may reside either locally in the home system, or at a centrally located server, or more preferably with portions of the recommendation engine spread across both locations. Sphere preferably delivers the majority of web services through either a proprietary API or by serving web pages (e.g., HTML or XML).

Control server 26 can also communicate with a customer database registration server 34 for storing user registration information, including demographic information, and with a commercial transaction server 36 for providing billing services based on content delivered to home system 12.

Sphere can surround the user with content control, such as for video, including without limitation: exploring, searching, obtaining detailed information, selecting channels, selecting categories, selecting new items, selecting most popular or most recent media, selecting top favorites, selecting most discussed, tagging content, viewing/screening of content, selection by rating, purchasing content, downloading content, transferring content to portable devices, and managing recommendations.

The configuration of Sphere can confer an ability to perform both primary and secondary activities within an integrated environment. By way of example and not limitation, primary activities may comprise any or all of the following, either separately or in combination: content browsing, surfing local/non-local content, finding related media, finding related product information, reading content meta-data, simple content searching, searching via sub-categories, one click purchasing of content, viewing of content, watching video, viewing photos, slide shows, viewing thumbnails of media, album art, jacket covers, listening to content, and tagging of content for later viewing. By way of example and not limitation, secondary activities may comprise any or all of the following: checking important information, weather, news, sports, stocks and so forth.

2. Preloading of Content.

A number of mechanisms are described for the preloading of content (e.g., movies, shows, documentaries, music, and so forth) onto manufactured electronic devices prior to shipment. A number of different devices can be subject to being loaded with content, such as personal computers, media computers, laptops, palmtops, tablet PCs, personal digital assistants (PDA), smart phones and any devices having sufficient disk and/or memory space within which preloading of content is viable.

In one implementation a series of systems are all loaded with the same content, wherein it is not personalized for specific users. The content to be preloaded is thus selected within the manufacturing process, and can be played by the user upon receipt of the device. Variations of this build process include sequential preloading, wherein groups of systems (e.g., every x number) are loaded with the same content, wherein content is changed between batches. Sequential preloading is particularly well-suited for distribution of segmented content across the P2P network landscape.

In another implementation the preloading of content can provide partial or full personalization of content downloading. For example, in a preferred implementation, the preloaded content comprises movies (e.g., SD or more preferably HD), or excerpts thereof, loaded in response to user input. It should be appreciated that HD content requires large amounts of storage, such as requiring about nearly 50-100 GB for loading two full length HD movies. If the content loaded in this manner is to remain secure, then the system preferably incorporates security measures toward preventing hacking of the material.

Preloading under the invention can support full and partial content loading. In one implementation of partial content loading, different segments of content elements (e.g., movies) are loaded onto different systems, wherein these systems when received and activated by the users form a peer-to-peer (P2P) network which collectively contains all the segments comprising a set of content downloads. In this way the method of the invention acts to preload the P2P network with content. The decision of which segments to load onto a system may also be personalized, such as based on where that system will be utilized, for example in response to the zip code of the purchaser, if known. In this way the preloaded content can be clustered so that segments within the P2P can be found locally. The system preferably retains the locations of the preloaded segments to aid in the distribution process; however, it will be appreciated that the registration of the distributed content can be provided in a number of different ways. In addition, the preloaded content, and content loaded after system receipt, can be duplicated, swapped, copied, and so forth across the P2P landscape to increase the accessibility of content resources across the network or portion thereof.

In one aspect of the invention the user can submit information about desirable content when ordering the system, wherein the content loaded to their system has a high probability of value to the user. In at least one implementation, the user desiring to receive the content fills out a profile sheet when ordering their system. The profile sheet asks questions relating to the type of content of interest for themselves in terms of movies, shows, documentaries, and so forth, as well as possibly collecting information about other prospective users of the system. This data can be used in the preload process as well as providing a jump-start for the recommendation engine when the unit is received by the user.

In an alternative implementation, upon entering this profile information, the ordering system generates a set of recommendations from which the user can select, or enter additional criterion for honing the profile. In this way, the recommendation engine gains more profile information while the probability of the user obtaining valued content is increased. In one implementation, the process may continue until all content slated for preload has been validated by the user. In this manner, the user is both incentivized toward initializing the profile and toward learning the recommendation process; wherein the user is perhaps more likely to utilize the recommendation engine upon receipt of the system.

3. Recommendation Engine and Process.

3.1 Operation.

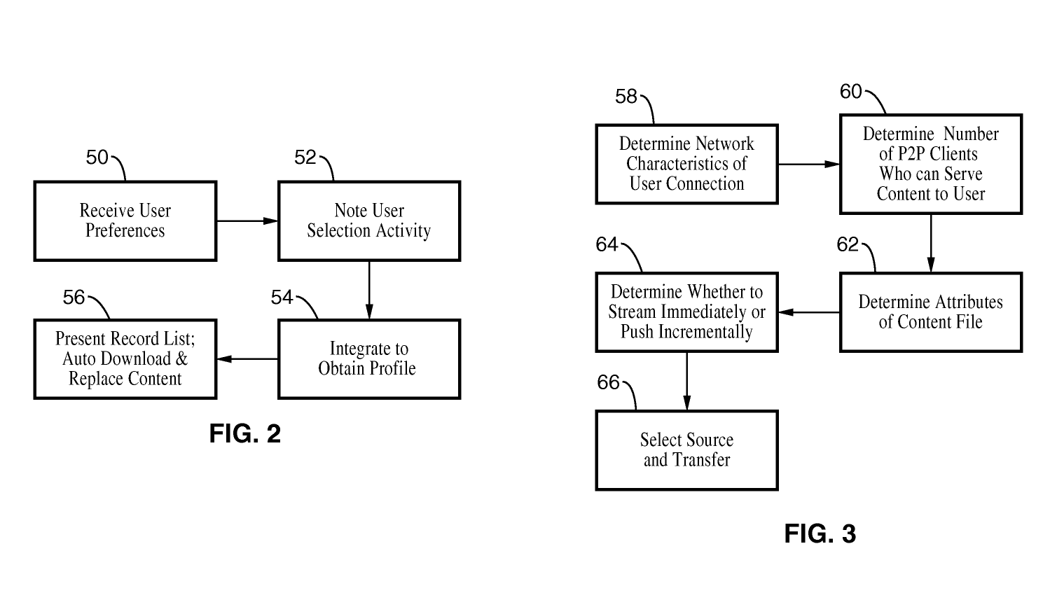

FIG. 2 illustrates steps in a personalized content delivery method. User preferences for content are collected and/or are received, at block 50, from various sources including, but not limited to, user-provided information and user history. The information directly entered by the user can include the following general categories: information about types of content sought, types of content to be avoided, limitations on arriving at content recommendations, and how those recommendations are to be acted upon.

Examples of the types of content include nature of the content (e.g., video, audio or image), genre (e.g., movie, series episode, travel, nature, sports, news, weather, and so forth), specifics within each genre (e.g., drama, historical/biographical, comedy, romantic-comedy, action, thriller, and other types). Additional types of information can include preferred directors, actors, plot lines, video subjects (i.e., vehicles, planes, ETs and so forth). A rating range can be selected, if desired. These preferences can be stored locally and/or more preferably within registration server 34.

In addition, at block 52 user activity can be registered by the control server 26 to collect information to be used in making content recommendations. By way of example and not limitation, the information may include user activities such as selection, viewing, and ordering. The viewer activity that can be monitored may include web activity, such as browsing, reading an online review, clicking on an advertising banner, clicking on elements within internet enhanced media content (e.g., an advertisement or product placement during a broadcast video stream), and so forth. Block 54 indicates a mode of the recommendation engine 28 wherein user selection activity is integrated with user-input preferences into a profile; for example, a profile developed for a home system 12 and/or the creation of multiple profiles developed for each user of home system 12, in which case users might be permitted to log on to the home system 12 so that the user control server 26 is kept apprised of the identity of the individual viewing content at any particular time.

According to one implementation the user can opt in to allow the recommendation engine to peruse one or more user directories (e.g., content directories), whereby the recommendation engine will garner information from those directories to aid in making accurate predictions on the desirability of given content. In the above case the recommendation engine can be configured as a “lifestyle recognition engine” to assess general lifestyle characteristics from which preconfigured media profile templates are loaded into the usage store. In this way a generalized and perhaps reasonably accurate media profile can be established.

In undertaking the building of a profile, a number of factors can be tracked in relation to the viewing history of the user, such as source of media (e.g., viewed from broadcast, cable, satellite, DVD media, and so forth), title, artist, genre, and broadcast time of a program watched by the user (e.g., beyond a threshold period such as five minutes) can be accounted for in the preferences. User activity, such as how often a particular show is viewed, can also be accounted for in the preferences. The preferences are configured to weight the information for desired content in response to the number of times viewed, while the show may be weighted even higher if it was selected for recording. In addition, according to one aspect, the user can give preference to certain contents being viewed, such as by signaling this preference while watching the content (e.g., pressing a preference button on the remote control). It should be recognized that the above are merely examples, while the operation of the heuristics utilized within recommendation engine 28 are not limiting, and models known in the art for predicting programming that might be desired by a user whose demographics and/or preferences are known may be used.

The recommended content itself can be downloaded to the user media device, and/or a preview of the content downloaded to the user, such as determined by user preferences and utilization of the Sphere system. For example, it may not be cost effective to download entire movie contents to a user that has never purchased a movie utilizing this service. In one mode of the invention, the recommendation engine determines whether it is more cost effective to send either previews or entire sets of content ready for access.

In one mode the recommendation engine takes into account special pricing, incentives and availability of content when making recommendations, in particular in response to user directives. For example a user that is motivated to buy content when it is offered at a discount, may set their profile with that attribute high on their list of desirable aspects (e.g., a slide control for trading off cost versus other factors). In this way the system is more apt to include recommendations for these discounted offers, or other attributes of the content deemed beneficial according to the user.

Home system 12 is preferably configured to allow recommendation engine 28 to gather information from recording devices, for instance digital video recorders (DVR), media players, STBs, and so forth, to incorporate this information into the usage data storage from which recommendations are based. For example, when the user selects a program (e.g., from a program table, or by setting channel and time) the recommendation engine determines the associated show and increases the priority of other episodes for that show, or relevant content. In a similar manner, the home system is also preferably configured to extract data for the recommendation engine when removable media is being played. An example of this is when a DVD, Blu-ray, (or media of any type and/or capacity) is played in some form of playback device, and then the recommendation engine collects the metadata, or extracts it from the content, and stores this priority information within the usage data storage.

In at least one implementation, the Sphere system allows the user to enter information about media content which they have an interest. For example, lists of possible content can be put forth for the user to indicate their level of interest. Interest information can be collected along with a priority of interest value as desired. This information can be used to direct the recommendation engine.

Furthermore, in one mode the system allows the user to enter information about content for which they have no interest (e.g., content already seen) and which they do not want included in the recommendations. For example a user may believe they have seen all episodes of a given show. In one mode the user is prompted to check a list to determine if they missed any episode of the series. In this case the system is configured to generate a list of episodes with associated information (e.g., title, story line, image thumbnails, and/or low resolution video excerpts), wherefrom the user can readily mark episodes which they have not seen and are interested, or more importantly, for which upon review they decide are worth obtaining or seeing once again.

Recommendation engine 28 recommends content, based on the profile, that can be downloaded to home system 12 and presented on display device 14 for viewing thereof. In a preferred embodiment each recommendation is first placed in a prioritized queue prior to download. In one mode the system incorporates human-readable fields into the queue and allows the user to preview recommendations prior to the content being downloaded—if the user desires. Once recommended content has been downloaded, with or without preview, the user is alerted and can access that content. Protected content within the recommendations will typically require executing a transaction to release the content to the user, such as a financial payment or release of content credits.

An input device 24, associated with home system 12, may for example comprise a remote control device for controlling viewing within home system 12. By way of example, input device 24 may be configured with a single button 38 (e.g., labeled “display list”, “content”, or “preference”) that can be toggled to immediately display the list of downloaded recommendations on the television. This list may be downloaded and stored in the home system 12 and may be periodically updated, such as for quick access when the button is toggled, or the list may be kept updated at the server and immediately downloaded for display when the button is toggled.

The profile information is analyzed in relation to a content database containing references to content elements along with information about each piece of content. In one configuration the content information comprises a collection of metadata. Content information may be collected by any desired ingestion method, or more preferably a combination of mechanisms to provide a broad base of information. In one mode of the invention, the system is configured to augment metadata information, or provide metadata for content for which no metadata could be obtained, by performing feature extraction on available content elements. An example of this extraction process includes registering scene changes, color saturation, color profiles and patterns, motion vectors (e.g., movement and rate), and so forth. During feature extraction, aspects of a piece of content, such as a movie, can be determined from the content itself. By way of example, the color profiles can detect whether the action is indoor or outdoor, mountain or ocean, personal interrelation, and so forth. The sound track often can be used to detect if the movie is comedic or a thriller. Motion vectors can be evaluated within the movie content to detect the level of action within the movie. It will be appreciated that many different aspects of the content can be extracted for comparison against the profile by the recommendation engine. In a preferred implementation, the system utilizes a combination of metadata from one or more sources, extracted data, and even feedback from the user, and/or other users, in categorizing content elements to which future recommendations are being made.

In response to matching profile content, such as from the content server 32, material can be selected for automatic downloading as per block 56 through control server 26 to home system 12, for example into the multimedia data store 16. In some cases of limited storage, the new material may replace material considered to be of less value, or potential value, to the customer.

At least one implementation of the invention provides for a recommendation process configured to span multiple value contexts (e.g., user value, distribution flow value, profitability). In addition, at least one implementation of the invention is configured with a sequential recommendation process, spanning multiple decision points. One example of these multiple context and decision recommendations can be termed a “sub-optimal” recommendation method.

In this sub-optimal recommendation aspect of the invention content is recommended although it may be considered less desirable with respect to the context of the recommendation process (e.g., user-centric recommendation process). Although sub-optimal in a first context, the selection decision benefits other contexts, such as toward smoothing content distribution and/or maximizing profitability of the downloaded recommendations. The selection of a sub-optimal content element can be performed in response to additional conditions (e.g., non-user), such as server, network, and P2P content access conditions which exist at the time of commencing a download of recommended content. Some metrics upon which sub-optimal selection are based may include status of the network, information on which content can be downloaded at a low opportunity-cost or with high-bandwidth, which servers have desired content and are ready to serve it, availability of all segments of the content on the P2P network, which content segments are needed at the user node to support the local P2P, and so forth. Additionally or alternatively, sub-optimization may be introduced (e.g., randomly, or in response to control server directives) to smooth the overall delivery of content, or to otherwise serve other beneficial contexts.

It will be appreciated that the optimality of recommendation is assessed in response to a given context; for example from a user context wherein user value or user value/cost ratio is considered, or from larger contexts that take into account value to the user as well as to the distribution system and its partners. The present system is not limited with regard to context of optimization, and may perform recommendation based on assessing any set of metrics, such as spanning contexts which include the user, profitability considerations, distribution considerations (e.g., P2P content availability, content server availability, delivery costs, flow balancing considerations, P2P content propagation characteristics), and so forth. Accordingly, sub-optimal selection can be considered an optimization process in which these other selection metrics are taken into account, either at the time the recommendation is put forth, or more preferably at the time a recommendation is selected, such as from the queue, in response to system and network conditions which exist at the time a download is to commence.

Preferably, in the content distribution step, unused bandwidth on home system 12 is utilized for downloading media via a “trickle-down” method. With more specificity, content files preferably are delivered during periods of no use, or low use, of the network by home system 12, so that the content is delivered in the background and has no effect, or minimal effect, on user internet interaction. User-selected media is given priority for delivery, with recommended content being delivered automatically, even if not requested, as storage space and bandwidth permits.

By way of example and not limitation, consider the example of a user viewing and/or recording episodes of “Show A”. The profile engine shown in FIG. 1 registers this information, which can be used to determine that both Show B and Show C have a high probability of being of interest to the user, for instance because they share a common genre, the same or similar personalities, or have been found to be highly appreciated by other viewers whom also have been watching Show A. In response to the high probability of Show B and Show C being desirable to the user.

According to at least one implementation the metrics utilized for determining recommendations include establishing one or more groups within which the user belongs, and utilizing content selection preferences of the group as a sole or partial basis upon which to recommend content. The elements of the group, or groups, may be established directly by the user (e.g., entry of information about other users), or in response to categories of content, media characteristics, causes, lifestyles, and so forth of the user. For example, the user may enter information about groups that they identify with, such as a political party, causes, religion/non-religion, sexual preference, sport/activity, mindset, and so forth. Although these are considered preferences which can be used directly for selecting content (e.g., content associated with a given group), these preferences are utilized in this instance to aid in selecting members of a group. In one implementation the group list is established in response to comparisons of historical media selection, such as identification of favorite content (e.g., movies and shows), in comparison with other members to establish the fit within the group. In one implementation the group list, or lists, are established in response to multiple entries and criterion, spanning multiple sets of criterion such as outlined above, to provide a broad basis of common interest.

In response to the user marking a recommendation as a poor fit (e.g., deleting content of a recommendation, deleting an entry from a recommendation queue, or other negative response about a recommendation), the recommendation engine is configured to track these adverse responses and to excise individuals from the list of group members if their behavior is found to be uncharacteristic of that group. The recommendation engine in at least one implementation of the invention can vary the number of persons in a group list of a user in response to characteristics, such as the fit. In addition, the recommendation engine can be implemented to allow groups to be identified as “antitype” groups, wherein the user desires selections to be made which are opposite to those of this antitype group.

In response to identification of a group the recommendation engine extrapolates content selection behavior of members of that group (e.g., without compromising privacy of any individuals within that group) as a weighting metric in determining what content the user may desire. In this way a recommendation may be based fully, or partially, on the specific content being accessed or downloaded by members of the group. Furthermore, in one implementation, feedback received on content and content recommendations from members of that group, or groups, are utilized as another decision weighting metric.

The recommendation engine according to at least one implementation can support establishing multiple groups for a given user. For example, with respect to comedies a user may identify with one group, while musically or with respect to documentaries they may identify with another group, and so forth.

Recommended content is preferably delivered by the system to the user device during time periods when sufficient bandwidth is available, such as when the user is not engaged in other activities (e.g., referred to herein as “trickle-down delivery”). The system alerts the user to the availability of these shows when one or more episodes (or sufficiently large excerpts thereof) have been completely delivered, or in accordance with system settings. In addition, the system alerts the user to whether there are any additional fees or conditions associated with the viewing (e.g., purchasing, renting) of the contents downloaded on the basis of recommendation from the recommendation engine.

If the recommended material which has been downloaded to the home system comprises protected content, then the content can only be released to the user in response to accepting the recommendation and executing some form of licensing transaction. For example terms are accepted for use of the content and then a payment is made (i.e., PayPal®, payment card, advertising credits, and so forth) in response to supplying of user identification. According to other examples protected content can be released to the user in exchange for a select number of advertising credits, which for instance the user has accumulated in response to viewing qualified advertising material as monitored by the Sphere system. It will be appreciated that non-protected content may be available immediately after download.

In addition, in one mode of the system, the reasons for recommending this content are put forth to the user. In the present example, the user is given information about the relationships between Show A, which they are viewing/recording, and these recommended shows. Often, the recommendation may be based on a number of factors. It will be appreciated that the user may be more inclined to take the recommendation seriously when understanding the basis on which the recommendation was made.

At least one implementation of the Sphere system is configured to allow the user to add web based content sources to the recommended download list. For example downloading selected web sites, such as selected from a web search, free content available from web sites, or other select content, for which insufficient bandwidth exists to provide real time content access.

The ability to recommend content within the Sphere system is preferably based on the union of a matrix of content selectors operating in harmony. The system utilizes direct input from the user, such as in the form of expressing interests, in concert with analyzing the content in which the user has shown interest. The heuristics for analyzing content of interest adopts one or more different mechanisms for assessing the value of possible content recommendations. For example, the system may utilize neighborhood selection mechanisms, such as collaborative filtering (CF) based on judgments of other users with similar demographics, or cosine-based similarity between users. One preferred mechanism for analyzing the value of suggestions utilizes a stochastic method, such as simulated annealing, performed utilizing “move”, “swap”, “swap-swap”, “swap-move” and similar order-changing mechanisms. These methods are preferably based on computing a cost (or value) function, such as in an iterative process. Information about the material stored on the system, and previous feedback from recommendations is also preferably utilized in properly assessing cost (value) or as a separate stage of processing (e.g., post-processing).

In one mode of the invention, the system provides the user with the opportunity to enter information about the value of the recommendation, so as to correct how the recommendation engine is arriving at these decisions. This feedback can be supplied either in the affirmative, thus affirming the recommendation of this show, or in the contrary sense, when the show was not desired and the user gives rationale to correct the recommendation engine. For example, the user may indicate that they are not interested in Show B, and as desired input information as to their reasoning, for instance marking a check box. Alternatively, user input can be captured through menuing, text capture, voice capture, and so forth. In one aspect of the invention, the metadata associated with the show can be used as keywords, or from which keyword information is generated, to create affirmative and negative responses about the recommendation. According to this mode of operation, the system utilizes this additional information to increase the value of recommendations put forth by the recommendation engine.

In another exemplary non-limiting scenario, the system registers the “channel surfing” activity of the user and detects when the user stops surfing to watch an entire episode of Show A. The recommendation engine can use this information in concert with additional information to optimize the potential value of material delivered to the user. For example, unless other information directs the recommendation in another direction, the recommendation engine may direct that trickle down delivery commence on one or more past episodes of Show A, such as for storage on content server 32. As a further example, the recommendation engine may then place at a lower priority the trickle down delivery of Show B and Show C.

It will be appreciated that the recommendation engine prioritizes objects of trickle down delivery toward optimizing the value of content brought to the user (a metric similar in kind to a return on investment), or other desired metrics and relationships. Accordingly, content is prioritized for transmission and/or for presentation purposes. Prioritized recommendations are ordered with a recommended content queue awaiting downloading, in at least one implementation that user can modify the recommendations in the queue as discussed below. User-selected content (and targeted advertising), for example, may have a higher priority for transmission than recommended content. The system provides the capability for this type of content to receive higher transmission priority. By way of example, the system should normally assert a higher priority to targeted advertising (e.g., for placement in playlists) than other advertising.

In one aspect of the invention, recommendations can be tailored in response to maximizing the ratio of value in relation to cost, a form of return on investment (ROI) for the prospective download. Ratio of cost with respect to anticipated benefit is analyzed toward providing highly cost effective selections. For example, the content selected with the highest potential user value (i.e., V=10) may have a cost (i.e., C=20) which makes the selection less attractive (i.e., V/C=0.5) than say a content element with a lower value (i.e., V=5) with a lower cost (i.e., C=5), having a better benefit to cost ratio (i.e., V/C=1). The recommendation engine according to this mode factors in costs, such as content costs, delivery cost, bandwidth costs, and so forth, wherein content having the highest benefit to cost ratio can be distributed to the user system first. To properly assess costs, the system is configured for tracking at least one content cost factor, and more preferably a number of cost factors. In one implementation, delivery information is registered and the system builds a delivery cost model relative to each given user. For example, tracking the effectiveness of the P2P local to the user in delivering the content elements, as well as the traffic of the servers local to the user. The modeling of cost factors allows for the rapid assessment of costs in relation to the value of a given resource.

At least one implementation of Sphere is configured for making ongoing recommendations, even though the prior recommendation have not yet been downloaded to recommendation area of the user system. Data about these ongoing recommendations are preferably stored in an area on the user system referred to herein as a recommended content queue. Preferably the recommendations are stored in a prioritized order, for example with the first on the queue (next to be downloaded) having the highest anticipated value, or value-to-cost ratio, or other value metric, to the user.

In a preferred implementation, the recommended content queue is user accessible and configured having each record of this queue comprising both machine readable data fields directed at controlling the actual download operation, as well as human-readable (or viewable) fields, providing a preview capability to the user. By way of example and not limitation, the human accessible data for the user may comprise content description (title, episode, length, etc.), optional thumbnail images, optional low-resolution video segments, cost factors (if any), reasoning for recommendation, and any other information which could be of use in making preview decisions.

The preview capability can give the user control over an arbitrarily large set of upcoming download recommendations, allowing the user to delete entries, change the priority of entries, and so forth, for items to be automatically downloaded over the extended period of time represented by the depth of the queue. In one mode, the user can configure the desired size of the recommended content queue.

Once this queue is filled, the recommendation engine will continue to perfect the recommendations based on a deeper analysis (e.g., iterative heuristics) or in response to the receipt of additional information. Accordingly, it should be appreciated that even after queuing, the recommendation engine can still change entries in this queue (e.g., delete, raise or lower priority, and so forth) based on further analysis. Recommendation analysis is preferably suspended when the user accesses the queue from the preview screen, so as to prevent presentation aliasing. Setting a small queue size, such as 0, 1 or 2, is the equivalent of performing the downloads without having a realistic chance of previewing them. In contrast, maintaining a large queue size, such as 100, provides the user ample opportunity to hone the recommendation list, thus greatly enhancing the value of the content that is actually downloaded, and increasing the ROI.

In one mode of the invention the system allows the user to enter information on the reason why records in the recommended content queue have been deleted, thus enhancing subsequent decisions of the recommendation engine.

The recommended content queue described above should not be confused with the content stored in the recommendation area, an area for recommendations whose associated content has been downloaded and is ready for access by the user.

Although, Sphere is particularly well-suited for collecting protected content items it can also be configured to allow the user to collect any types of content.

Another aspect of the recommendation engine provides a means for controlling the distribution of advertising through the recommendation engine providing ongoing user control of how and which offers are to be sent to the user. In this aspect, the recommendation engine determines which advertising should be most advantageous to the user, such as in response to data collected in the profile and the types of benefits provided by the available advertisements.

In at least one implementation of advertising control, the recommendation engine directs how and when advertising is to be played out to the user. It will be appreciated that the user will have incentives for playing these advertisements, such as to gain content credits and similar benefits. The system allows the advertising to the played out in a manner that is effective for the advertisers and/or convenient for the users, while tracking the viewing of these advertisements and managing the accrual of incentives.

Advertisements in some cases have a tie in with downloaded content, such as being products and services related to the content (e.g., sales of the movie, movie soundtracks, books, branded products, video games, and so forth).

The system controls the playback of these advertisements according to a set of system parameters, including conditions on the advertising (e.g., in qualifying as an incentive), as well as user selected “convenience” parameters. Sphere controls the placement of the advertisements, such as at selected points, for example at major scene changes, (e.g., in response to metadata entries of appropriate location) within a show, or movie. These can be played based at intervals, or between content elements, and so forth as directed by Sphere programming. The rate, number, and/or time period at which these advertisements are played out can also be controlled, such as according to user and/or advertiser parameters, so as to receive a desired level of accrued benefit without undue disruption of content viewing.

The benefits of the advertisements to the user is also enhanced as at least one implementation of Sphere allows the user to provide input on the types of items they are interested in purchasing. Users can decide to disclose any items that they may be on the market for, or would have an interest in, or this information can be gleaned from an analysis of the movie and show data collected. The advertising information within the profile can be manipulated by the user in a number of ways. For example, the user can input purchase interests, and/or reprioritize a list of existing purchase needs/interests (e.g., they may be considering the purchase of a motorcycle, travel trailer, dishwasher, new computer, and so forth).

In one implementation, user activity in relation to these advertisements is tracked if opted in by the user, such as in response to selecting links for additional information, contacting companies about the products (e.g., emails, web visits), and/or purchases (e.g., selections, and transactions executed). In this way the user can accrue additional incentives with respect to validated interest, on this and/or other offers.

If the user elects not to make any preferences known by which their product and service needs may be more readily met by the advertising generated from the recommendation engine, then they may be sent largely generic advertising.

In one mode, the user assigns priority or relative merit value to the different forms of benefits and opts in to selected types and forms of advertising promotions. For example, the viewing of advertising can be utilized as payment towards viewing, renting, or owning material through the Sphere system. Sphere is configured to perform a recommendation process (heuristics) in response to information stored in the profile so as to control the viewing and use of advertising to best suit the desires of the viewer within the context of the advertisers' objectives.

By way of example and not limitation, one implementation of the recommendation engine for controlling advertising selections is configured with a set of UI slide controls (e.g., the number and type of which can be selected by the user, or additions made to a simple default set by more sophisticated users) that select the tradeoffs being made. For example, users want the advertising to be relevant, but they also want the advertising to provide a high value (e.g., redemption for content), wherein the slide control can direct the system as to the users' preferred level of tradeoff to be made. User control of advertising can thus emerge from checkboxes, lists, slide controls, and so forth allowing the user to tailor their desires while fully optimizing the intent of the respective advertisers in properly placed advertising.

At least one implementation of Sphere solicits recommendations from a user for sending to their friends, relatives and acquaintances. These recommendations are preferably sent in an email format with user notes, and may optionally include metadata description of the content element, as well as previews of the content.

Under one mode of the invention, recommendations are tailored in response to the user interface mode, such as, for example, whether in a two-foot UI mode or a ten-foot UI mode. In addition, one mode of the invention is configured for taking into account prevailing conditions, such as the state of the attached monitor device, the number of viewers, and so forth.

Further aspects of the recommendation engine can provide for personalization in other areas. For example, in one aspect of the invention, the recommendation engine uses the collected profile data to personalize the offerings of an Internet radio service, and/or create a custom form of Internet radio service. Alternatively, the recommendations through Sphere can be utilized for generating additional channels with personalized content, and/or content directed at the user in response to recommendation of the recommendation engine.

Still further aspects of recommendation within Sphere can be coupled as desired to other paid and unpaid services, for example, cable subscriptions, premium sports bundles, news services, magazine subscriptions, newspaper subscriptions, or even services traditionally associated with paper materials/guides, such as may be received as channel guides for public television stations, or even for services for which the user is regularly paying bills. In this context, the Sphere system not only acts as a liaison to these services, allowing seamless integration of the content, but it is configured to allow the user to connect with these services for customizing their operation in response to output from the recommendation engine. In this way the user gains a complete sphere of control over their content environment.

4. Delivery Process.

FIG. 3 illustrates another advantage that may be provided by present principles, in particular, optimizing of the content delivery mechanism. In at least one implementation of Sphere, the content can be delivered from server resources, peer resources, or a combination of server and peer resources. Content can be delivered integrally from these resources or in parcels, in which segments of the content are delivered to the user from different peers or servers. In preparing to deliver content, the system assesses the availability and status of delivery resources.

Commencing at block 58, network characteristics are determined. These can include network characteristics of the connection from user interface 18, including its bandwidth. At block 60, the number of peers 22 that can currently serve content is determined, and then at block 62 attributes of the file, including its size, containing the content to be provided are determined. Next, at block 64 it is determined whether content is actively being streamed to home system 12, indicating that the demanded content is expected by the user to be watched immediately. If the home system 12 is not receiving content from external sources the above-mentioned incremental download during off-peak periods may be used. Based on these considerations, at block 66 the source is selected (e.g., the server 26 or the P2P network 20) from which the content is to be provided.

As an example, if the requested or recommended content is in standard definition (SD) format and is not currently available via the P2P network 20, the server 26 is selected as the delivery source. On the other hand, if the content is in high definition (HD) format and is to be automatically delivered to home system 12 in accordance with principles above, and there are also a number of other home networks to which this piece is designated for delivery, or that can serve as sources for the content, the P2P network 20 can be utilized to deliver the content to the various home systems. It should be appreciated that more than a single peer 22 can be utilized for distributing the content, in fact in one mode of the invention multiple peers 22 negotiate with a central Sphere control server, and/or one another, to collectively send the desired files. For example, one peer may send a first file segment while another peer sends a second file segment, potentially simultaneously, to home system 12.

As another example, if the number of available peers 22 is known and a piece of HD content is being transferred to home system 12 via the P2P network 20, and during transmission a number of peers 22 serving this content are unavailable, the overall throughput of the file through the P2P network 20 may be severely hampered. Accordingly, transmission of the file can be transferred to server 26, in full or in part. Alternatively, or additionally, the system may solicit additional P2P peers 22 to assist in the delivery of this piece of content. The server 26, which communicates with the peer network 20, may coordinate the delivery selection between this and other servers and members of peer network 20. Also, a combination of server 26 and peer network 20 may be used to deliver content.

In at least one implementation security mechanisms can be adopted to protect content within the peers of the P2P network, such as utilizing a port hopping scheme to increase security. By way of example and not limitation the use of port hopping is directed at addressing the issue of having to open certain ports for communicating content segments with other peers, for example pushing content segments to clients. Traditionally, the router and firewall have to be configured appropriately so that the packet flow through these ports is enabled. Leaving these ports open may subject the systems to a security risk, because as soon as the ports are open the system can be attacked by malicious software. In one implementation of port hopping security according to the present invention, the port numbers are changed, such as in a pseudo-random manner. Parameters of the pseudo random generator are encrypted and broadcast well in advance of their use so that other peers maintain synchronization with the open ports allowing traffic to flow uninterrupted across the P2P network. It should be appreciated that by utilizing this approach, or variations thereof, ordinary software port scanning viruses are not able to make use of open ports even if they are detected, because they only have access to these ports for a limited time, such as on the order of a few milliseconds.

In one aspect of the distribution process incentives are provided to those who support the downloading of content to other peers under the auspices of the Sphere system. The system identifies participants in the P2P network and registers the content being served by these resources, such as the amount of data served (i.e., in Gigabytes) overall time over which content is made available, reliability of content serving, cost of delivery, latency of delivery, and combinations thereof. Delivery is tracked, such as periodically, as the basis of generating the incentives and thus inducing P2P participation. Redemption of incentives, according to one embodiment, provides the user with access to content resources or provide discounts or coupons redeemable towards obtaining downloadable content (e.g., rental or sales). Less preferably, the incentives can comprise cash or any desired non-cash incentives which are generated in response to the level of support provided to P2P clients.

In at least one implementation, the user can opt-in for loading a file clean-up utility to enhance the availability of storage space for content and segments of content, such as for distribution over the P2P. It will be generally recognized that users often have large amounts of storage space on their system with outdated content, and content of little or no value. In order to help the user prevent the buildup of these files, and the associated loss of space, a tailored disk space utility is preferably installed with the Sphere system which monitors file usage and recommends that the user look into deleting this content which may not be of any further use to the user. Examples of files which the user may want to delete, include: older (unused) versions of applications, outdated temporary files, installation files, duplicates of media, application installation files, and so forth. In addition, the system preferably recommends archiving content that has not been accessed in a long period of time. In this way the Sphere system aids the user in maximizing the amount of space into which media content may be loaded, and in particular into which content can be loaded for sharing across the P2P network with other clients.

In one implementation selected participating users distributed in the P2P landscape are sent new releases (e.g., in advance of the regular release) through the content distribution network (CDN), so as to seed the P2P network with the newly released content. In this way the P2P network can be readily loaded with new content, to readily support wide distribution.

In one implementation the amount of downloading bandwidth allocated to a user is determined in response to the amount of revenue derived from that user. This model can be utilized for other aspects of the invention, wherein users generating the largest revenue for the Sphere system garner the largest rewards from utilizing the system.

In a related distribution aspect, users whose content downloads must be sent by a CDN are charged a higher fee for the privilege. These users may be those that choose not to participate in serving content within a P2P network (e.g., they opt out of participation), or that have a serving record that is below a predetermined threshold, or that specifically select to obtain content through the CDN, or other factors, or a combination thereof which may contribute to the decision to charge a premium for the download being conducted over the CDN. This can be utilized as another incentive for users to participate in the P2P distribution mechanism according to the present invention. Users participating in the P2P serving can also be advantageously provided higher levels of service (e.g., lower latency) as another form of incentive.

Users may be categorized into different tiers of distribution service in response to P2P participation, quantity of downloads, associated subscriptions services and so forth. Generally, the system is configured to download content via the P2P configuration whenever it is available. In situations wherein the user selects to obtain the content via P2P, and is qualified to do so, but the content is only available via CDN then typically the system would not charge the premium as it was not their lack of participation or unwillingness that led to the use of the CDN instead of the P2P. It will be appreciated that segments of a given piece of content can be obtained from a combination of CDN and P2P depending on availability, cost and other factors.

One implementation of the system is configured to also allow for physical delivery of content as a convenience to the user. In some instances it will be appreciated that certain media may not be readily available for download (e.g., not accessible in the peer-to-peer network), for instance older videos or albums. In one mode of system operation, the user is alerted to this situation and given options for ordering physical media. The physical media can thus be ordered within the same transaction as downloaded media, thus saving the user both time and trouble. In this mode the Sphere system can be coupled to a physical order fulfillment center, or it may seamlessly interface (e.g., XML) with a third party order fulfillment service.

Furthermore, the system preferably provides the user with an option of physical delivery on any order (e.g., perhaps in response to user preference setting) as they may not be in a rush to obtain the content and prefer a physical delivery of the video or music. Physical delivery can be obtained in an integrated manner within the Sphere system in a number of different ways. For example, the retail content package can be sent including the printed cover and content flyer. In another mode, the system allows the user to select physical media that is “burned” at a fulfillment center, and may contain copies of the jacket and paper contents. The user can optionally elect to “burn” more than one title on a disk as space allows (e.g., a number of SD movies on a Blu-ray disk), and to save money by not receiving a printed jacket and contents flyer. It will be appreciated that a physical fulfillment center could deliver to the user entire collections that would otherwise require long spans of time for downloading.

In one mode the system can suggest ordering of boxed sets when a user interest in one or more episodes of that show, or sequence of movies is registered by the system. For example, consider the user ordering the downloading of one or more episodes of the sitcom “M*A*S*H”, wherein Sphere can query the user for ordering the complete boxed anniversary set. In this way the system can provide a convenience feature to the user while increasing revenue.

5. Backend Services.

A number of backend services can be provided by the Sphere system, including but not limited to the following.

(1) Contents Ingestion: One aspect is configured for ingesting contents from multiple third party web content and advertising content providers. These can be handled in a range of formats and utilizing a variety of digital rights management (DRM) techniques.

(2) License Delivery: One aspect is configured for working with license servers (e.g., third party contents providers) to manage the authentication process of protected contents.

(3) Account Management: One aspect is configured for registering and managing Sphere user accounts. Additionally, the synchronization of contents is preferably provided as it is published on the backend server.

(4) Sharing Account Information: One aspect is configured for selective communication of account information to third party contents providers with user consent. In this way registration within the Sphere system can automatically link the user to additional services and functionality at user discretion.

(5) Content Source: Sphere can provide, or be coupled with, various content sources, such as the following: (a) movie content sources (e.g., sales, rental); (b) premium content sources (e.g., pay-per-view type services); (c) personalized content (e.g., stocks of interest, bot news feeds, blogs, communication from persons and companies at the discretion of the user, and so forth).

(6) Contents Delivery: Backend system can support content delivery in which client applications are configured to automatically trigger the contents delivery from the server based on the analysis from the recommendation engine. Also Sphere can be tied into a physical delivery mechanism, if conditions or user preference dictate.

(7) License Delivery: Backend system provides capability to work with license servers from third party content providers to manage content authentication of protected content.

(8) Content Management: Sphere can provide, or be coupled with, a means for managing content by the end-users. By way of example, these may include, but are not limited to, the following: (a) setting detailed parameters for the media control software; (b) defining interactions with other media devices, such as portable devices; (c) annotating content and associating different elements of content; and (d) synchronization of content and management thereof.

By way of example and not limitation, premium movies may be sourced from partners serving as content fulfillment houses, wherein Sphere provides content delivery and financial transaction services with single-account sign-in. This engagement model does not dictate exclusivity. In providing news services, Sphere can provide for the delivery of free personalized news content (e.g., embedded with advertising). Paid upgraded services can be provided, such as according to a paid subscription. Revenue can be obtained from ads, monthly subscriptions, or revenue sharing. An Internet radio service can be provided in which Sphere provides additional channels personalized for the user based on the recommendation engine. A photo service on Sphere can, for example, provide local functions for photo organization and aggregation over a home network with a partner providing a baseline feature set as a free service to stimulate the subscription sign up process. Upgraded subscriptions provide additional services, such as photo storage, printing, and sharing services. Sphere can also provide personalized weather services. These services may be accompanied by embedded advertising, such as ad sections to bolster revenue.

According to one aspect of content management a contents management website can be utilized for managing a number of tasks, such as (a) setting parameters for the software; (b) management of contents delivery; (c) defining interaction with other devices; (d) reading/adding contents comments; (e) synchronization of content and content deliver, and similar forms of content management.

6. User Interface Configurations.

The Sphere system is configured for operation within a number of different operating environments, including those having different hardware, different interface configurations and differing usage scenarios.

It will be appreciated that the media content control offered by Sphere is applicable to all personal computer systems, media computers, laptops, tablet PCs, PDA, smart phones and similar computing devices, as well as to embedded devices, such as found within television sets, vehicles, and so forth.

Sphere can be utilized with any desired form of user interfacing, for example various displays, keyboards, mice, pointing devices and the like. One preferred user interface for use in relaxed use scenarios, for example when watching content on a television set, is the use of a free-space input device which detects movements in space of the controller and selection and control of the interface. Use of the free-space input device enhances the feeling of immersion into the Sphere environment.

In at least one implementation of the Sphere system, control or augmentation of the recommendation process is facilitated by one or more recommendation controls accessible on the remote control device. This control can be implemented in a number of ways. For example a “preferred” button may be integrated on the remote control as represented by button 38 shown in FIG. 1, and coupled to user input device 24. The user can press this button in order to boost the preference that the recommendation engine associates with the currently viewed piece of content. To provide a scaled input, the button may be pressed more than once to increase priority, or the button held down. In addition, the system preferably provides feedback on the increased priority the content is being given, for example displaying a preference icon containing a priority number from 1-10, as well as optionally a portion of the available metadata, such as title, episode number, and date.

Alternatively, a single recommendation button can be utilized for accessing recommended content, recommendation parameters, as well as to explicitly change the priority of the content presently being viewed.

Using the single button example, if the user presses the button shortly, then waits a sufficient delay, then presses it again and holds it down, the button can also be used to scale down priority. This negative priority scaling can be used to correct an earlier input, or more typically to direct the recommendation engine that the show is not of value to the user; such as to inform the recommendation engine that “after watching this show (or portion thereof) I'm not at all interested in it”.

In one preferred single button recommendation example, pressing the recommendation (or “preference”) button brings up a menu displaying the current priority as well as menu options with the first option to change priority being initially selected. Pressing of one set of buttons (e.g., the up/down controls) on the remote thus explicitly change the recommendation priority positively/negatively for the present content. Pressing another set of buttons (e.g., the right/left controls) in this case would allow the user to select from various recommendation control options, such as checking available content, deleting of unwanted recommendations, previewing materials to enhance recommendation accuracy, entering additional information to enhance recommendations, ordering recommended content and so forth. It will be appreciated that one of ordinary skill in the art can change how recommendation control is explicitly entered, without departing from the teachings of the present invention.

It should be appreciated that more elaborate control of priority may be employed, such as providing more or different forms of input selectors which modify recommendation engine priority for the content being viewed. It should also be appreciated that dedicated hardware devices (e.g., television sets) may require additional remote control buttons and programming to provide these additional levels of interactive control.

7. Usage Scenarios.

As a starting reference point on usage scenarios, the user experience has been divided into three broadly defined usage scenarios: (1) limited-time focused usage; (2) extended-time focused usage; and (3) extended-time passive usage. Each of these scenarios is clarified as follows.

7.1 Usage Scenario 1: Limited-time Focused.

This is loosely defined as interaction with Sphere over a limited time on a limited set of focused actions. Typically, this form of activity involves a user spending short bursts of time with Sphere or the device they are using to access content. This case is tightly coupled to the environment, the tasks, or the actual limitations/focus of the device itself. As a simple example, a user might walk over to an audio playback device, choose a music playlist, press play, and then walk away. The concept of limited-time focus tasks is further exemplified by these examples: playing music, running a photo slide show, playing a short video, checking weather, checking news, checking the date and/or time, checking traffic, checking address, and so forth.

By way of illustration, the following are examples of environments where the user could spend a limited interaction time: automobile, public transportation (e.g., train, bus, commuter van, and so forth), and/or mobile (e.g., walking, standing in public area, café, restaurant, sports club, and the like). The devices upon which the user would interact in this limited-time focused activity could likely be characterized as having: screen sizes of 1″ to 7″, low cost, low power, limited performance, limited (focused) set of functionality, and limited I/O (input/output) capability (e.g., limited set of keys and navigation controls). Illustrative examples of the above may include: universal remote controls with small UI, mobile phone, micro-PC/UMPC (e.g., touch input, screen sizes ranging from 2″-7″ diagonal), PDA/Pocket PC; digital picture frame, and audio playback devices.

7.2 Usage Scenario 2: Extended-Time Focused.

This usage scenario refers to a user capable and interested in remaining stationary, focused on one or more tasks that require a greater investment of time from the user.

Generally, the environment is one in which the user can remain stationary for a somewhat extended period of time without feeling uncomfortable. Due to the nature of the tasks to be performed, they most likely require a flat surface or a surface where a keyboard is utilized as one of the types of input methods. By way of example and not limitation, the possible locations may include: at home, den, office (home/work), kitchen (e.g., preparation of meals or at dining table), bedroom, outside, café or restaurant, dorm room, class room, office, and so forth.

The devices used in this category allow for more detailed input, such as both character and pointer inputs (e.g., keyboard and mouse or equivalent functionality), as well as outputs. One prominent type of device in this category are personal computers (e.g., desktops, notebooks, sub-notebooks, and similar).

In terms of the Sphere system, the types of tasks particularly well suited for implementation in this case involve management functionality, such as managing a personal library of content and media. By way of example and not limitation, these functions may include the following: managing account information, sign on information, billing information, address information, checking account status, setting detailed parameters of the software, management of the content library, determination of material to be downloaded, determining where to download, deleting content, adding content to library, executing a content purchase, moving content, advanced searches, adding comments to content, tagging content, organizing content into categories, editing content, transferring content to portable devices, importing content to devices, reading content comments and similar functionality.

7.3 Usage Scenario 3: Extended-Time Passive.

This refers to a user who is willing to spend an extended amount of time with the Sphere system, typically with a more relaxed focus (e.g., passive, relaxed), such as watching a movie, in which a user is typically less constrained with regard to accomplishing immediate objectives.

The perceived difference in this scenario is that the environment allows for the user to become relaxed and fall into a passive interaction with the UI. By way of example, the environment may include any of the following: any room in the home or apartment (e.g., living room, bedroom, family room, home theater room, entertainment room, patio/deck, and so forth), dorm room, airplane, passenger seating areas of an automobile, and so forth.

The devices which seem particularly well-suited to this extended-time focus scenario are those which best accommodate a relaxed interaction. Characteristics of a relaxed interaction involve larger screen sizes (able to be viewed from a distance) and easily operated user interfaces, preferably capable of remote operation (operation over a distance). The distance in a room may be on the order of 10 feet (˜3 meters), though it can readily range from a foot or two up to 30 or so feet. In view of the extended distance operation, it will be appreciated that the user is typically interacting directly with the device, but through a separate input device that allows remote control of the main device. To provide the best user experience possible in this user scenario, the remote input device and the UI should be developed in conjunction with each other. By way of example, the screen would typically be about 26 inches or larger, while the remote control would typically be configured for executing a limited set of commands on the device itself.

The nature of this extended-time scenario largely defines the range of tasks the user may be willing to perform. In some cases, these tasks may be limited to navigational tasks, such as browsing, simple searching, purchasing, and similar operations. The list that follows includes a number of illustrative examples, categorized as primary and secondary focus activities. Primary focus activities include, but are not limited to: content browsing (e.g., surfing content, finding related media, finding related product information, reading brief content meta-data), simple content searching (i.e., searching via sub-categories), one click purchasing of content, viewing content (e.g., watching video, viewing photos, viewing slide shows, viewing media thumbnails (e.g., album art, jacket covers), listening to content, and tagging content for later viewing. Secondary focus activities include, but are not limited to: checking important information (e.g., weather, news, stock, sports), and so forth.

It should be appreciated that the Sphere system is configured to support user anonymity in these different use scenarios, in which the historical data is used for aiding user interests while maintaining user privacy.

8. Content Ingestion for Sphere.

The process of ingesting content into the system for later dispersal involves the collection of metadata as well as actual content. It will be appreciated that the term “metadata” is used herein to represent data that describes other data, in particular, data that represents the objects which are to be published. Metadata describing a movie, for example, typically would include content format, title, genre, description, year published, director, actor, studio, soundtrack information, and so forth. The metadata information can be extended to include any desired material about the content element.

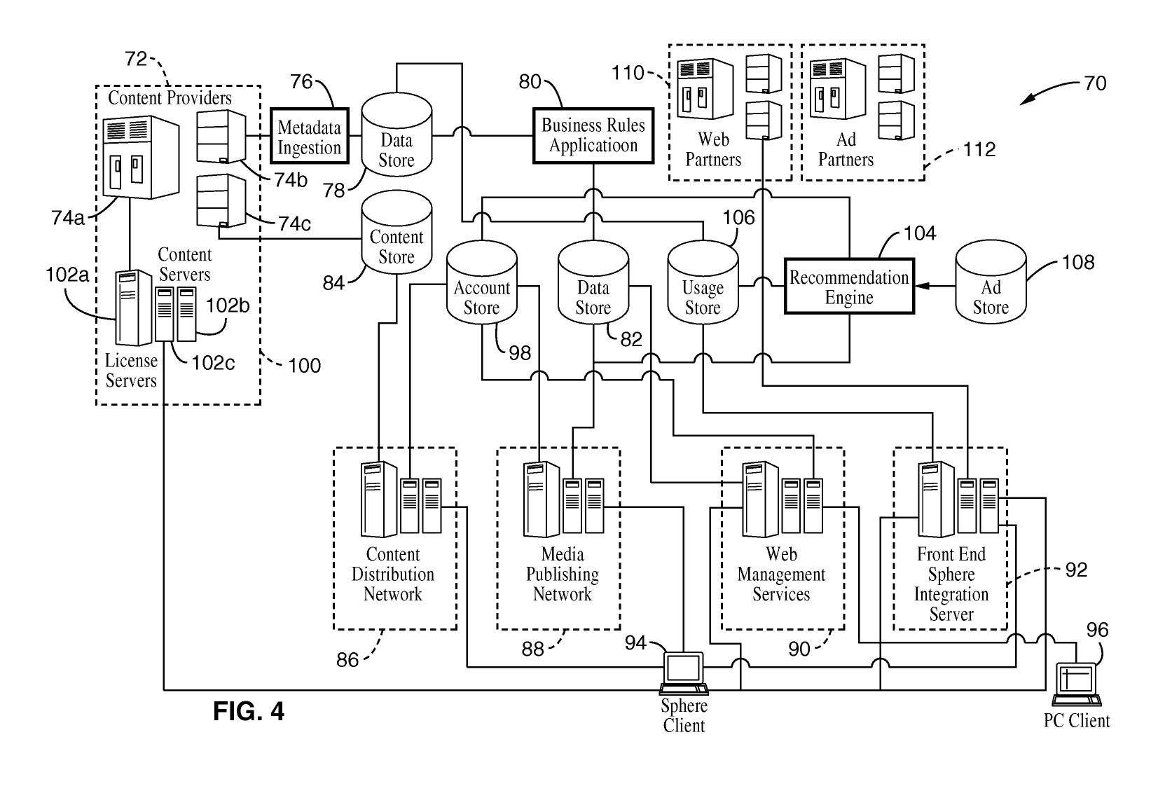

FIG. 4 shows the flow of metadata and content for use by the Sphere system. Metadata is shown being ingested from a group 72 of content providers 74a, 74b, 74c through a metadata ingestion process 76 into a data store 78, from which a business rules application 80 operates. Content is received from content providers 72 and stored in a content store 84. In the implementation shown, the content providers supply both metadata and content. Metadata is preferably converted into an appropriate format for the system during the metadata ingestion process and placed in data store 78.

The system according to at least one implementation supports both programmatic and user initiated extensions of metadata. As additional objects are added, the system preferably is configured to extend the metadata to incorporate previously undefined relationships, ratings, and so forth. It is considered preferred that the Sphere system not impose any practical limitations on the nature or type of metadata extensions which are allowed. The system according to at least one implementation supports the ingestion of metadata from multiple sources, therefore creating a hybrid metadata set. Metadata from the content owner is often incomplete, wherein additional benefits are attained by acquiring additional metadata from alternate sources. The system is configured to ingest metadata and content from multiple providers and users, with the end result being a more useful set of metadata.

It will be appreciated that metadata for a given content element can comprise a wide range of information about the element, which may include by way of example: content type, format, title, date, duration, cast, abstract, special features, and other information about the content element as desired.

According to one aspect of the invention, metadata can be extended to include information which supports the control and generation of advertising content in relation to content element. For example, metadata strings can be associated with product placements, wherein a specifier for an item is included along with information and contact information for that item. In one instance the time (or time range), location (or location range), identification for a product is included along with information about the product, links (e.g., web address, email address, phone number, store) wherefrom the item can be obtained. In this way users within the Sphere environment can select or hover over items on the screen in order to obtain information, or place orders, for these products and services.

According to another aspect of the invention, the metadata can rank and/or characterize insertion points for advertising content. For example, a ranking of locations, such as scene changes, wherein ads can be inserted with minimal disruption of content flow. One implementation of this metadata ad marking includes an identifier for the location in the content (e.g., a time offset), and a ranking of the “value” of this location within the content (e.g., value from 0-7). Rank in this case may be based on locations which are least disruptive to the user experience. The ranking can be ordered (e.g., each entry in the list with a unique value), or non-ordered (e.g., each entry having a value from n to p).

Returning to the description of FIG. 4, it is seen that business rules (pricing, promotions, and so forth) are applied at block 80. Then after updating with location information for content acquisition, the metadata is stored for use by the Sphere system. Meanwhile, a single copy of each piece of content is placed in a content store 84 to be used by content distribution network 86, such as in serving Sphere client 94. The business rules process 80 supports the definition and application of business rules that define pricing, bundles, campaigns, encoding requirements, time-based, geographic distribution limitations, and targeted offers of the content. This functionality is preferably provided on an individual object level and all levels of object hierarchy. Business rule definition is preferably supported through both an administration application and a programming interface.

Once both content and metadata have been ingested, it may be published to the media publishing network 88 and the web management services 90 (e.g., web servers), while the content is sent to content distribution network 86. The media publishing network pushes the metadata to Sphere client 94, which in turn can display it as an appropriate content library as shown in the figure.

Sphere, according to at least one implementation, supports automated, programmatic ingestion of content, such as through an Application Programming Interface (API) from a variety of content providers, providing content of different types. This support should include the capability to map from schema of the content provider (e.g., XML). The application programming interface (API) should be made available, along with documentation and/or training, to the Sphere service provider.

A user at client 94 may select content directly from the Sphere client interface, in which case the request flows directly back through the media publishing network 88 to the account of the individual located in an account store 98. A user may use a PC client 96 to access the web interface, such as on the web management servers 90, as shown in the figure to select content to download and have it placed in their account in the account store. In either case, the request results in content being placed in the selected device queue in content distribution network 86.

In one implementation of the invention, after content is delivered to Sphere client 94, the client device requests a license from a license server 100, such as including servers 102a, 102b and 102c, maintained by the content provider. The content provider fulfills the license request with a data flow shown coming back to the Sphere client, wherein the content may be enjoyed per the license terms.

Usage data for the recommendation engine 104 is accumulated, such as by front end servers, and placed in usage store 106. The recommendation engine 104 analyzes data, such as usage, within the data for a given user toward developing recommendations. These recommendations are placed in account store 98, such as within a recommended content queue, and then accessed by lower level device queues in the content distribution network, for silent (trickle) download. Similarly an ad store 108 is connected to the recommendation engine to optimize the use and placement of advertising within the content.

Web partners 110 and advertising partners 112 are shown in FIG. 4 within at least one implementation of the Sphere system. The term “web partners” is used herein to denote one or more web service providers which cooperate in providing services to Sphere customers.

Front end integration services 92 are shown in the figure coupled to the usage store and Sphere client. In view of the need to deliver content to different types of client devices, for instance those with limited input or display capabilities, it is preferable that the web pages and media delivered by these services is formatted to the device. This access is preferably provided through a common interface for the delivery of classes of web services, as opposed to having each individual product interfacing directly with a different proprietary third party service. The purpose of front end servers 92 is to facilitate the integration of web partners, addressing the issues noted above, as well as to gather customer usage information.

Advertising partners associated with the Sphere system generate ads associated with content, for example similar to traditional television commercials, banner ads, click-through ads, other types of ads and combinations thereof. In at least one implementation Sphere determines which targeted advertising is to be generated by utilizing the recommendation engine in a manner similar to how the recommendation engine arrives at content having the highest probability of user value. In a similar manner the recommendation engine analyzes usage data and ads available in the ad store to determine the appropriate ad(s) to be delivered to a given customer, so as to maximize value to the advertiser within the confines which are set according to the user opt-in and selections. It will be appreciated that the Sphere system can model content as having a positive or neutral cost to obtain, whereas advertising has a negative or neutral cost to obtain (that is they are revenue positive to the user). Ads are placed in the queue of the user and downloaded to the client device, where the client application will output the material as deemed appropriate. Additionally, ads that are more appropriate for a web environment will be displayed on the web interface, for example customers will view them upon accessing the web site from a PC.

9. Summarizing Sphere Capabilities.

9.1 General Recommendation Process.

One of the important aspects of the Sphere media platform regards the recommendation mechanism that can automatically “stock” the user system with downloaded media content which is ready for viewing, or unlocking followed by viewing.

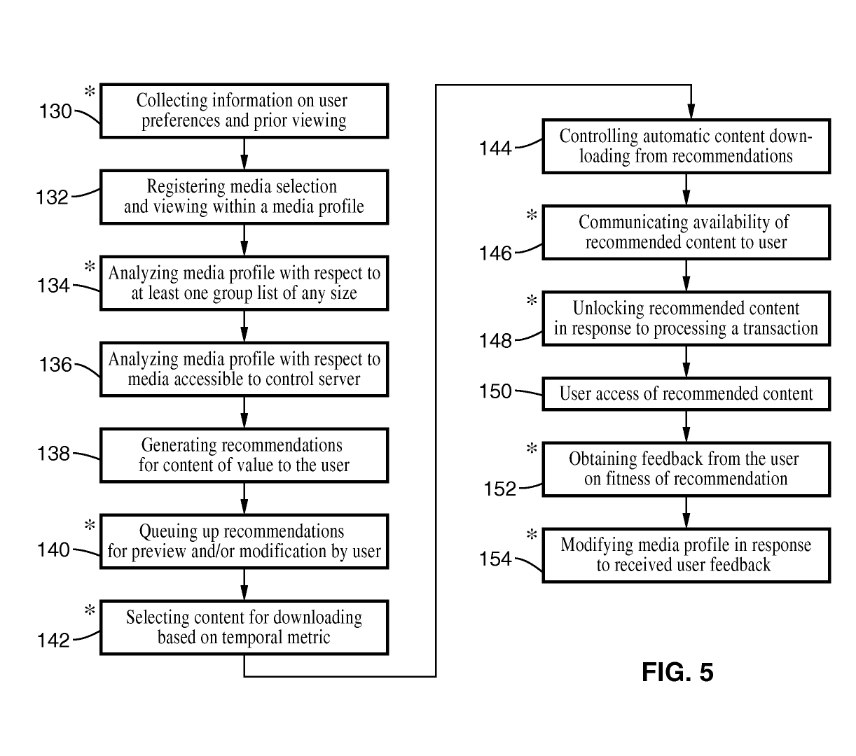

FIG. 5 illustrates by way of example a flowchart of the content recommendation method according to aspects of the present invention. The Represented in block 130 is an optional step of collecting information on user preferences and prior viewing, for example collected prior to activating the recommendation engine. Media selection and viewing is registered and stored in a media profile as per block 132. The recommendation engine stores information within the user profile about material viewed by the user, or selected by the user, such as in response to purchases for downloadable media content, physical media content, or other items to which media content can be associated (e.g., characters portrayed in the media, subjects, activities, life styles, and so forth). The recommendation engine analyzes the media profile, such as periodically, or on an ongoing basis, or in response to a depleted state of the recommendation queue (content elements awaiting download), or the recommendation list (content already downloaded to the user). The media profile is optionally analyzed with respect to one or more group lists, and information associated with preferences of the members of that group list, as per block 134. The media profile is compared with the media content accessible to the control server as per block 136 to determine which accessible media is expected to be of the highest value, or highest value to cost metric ratio (e.g., monetary cost, non-monetary exchange cost (i.e., coupons), bandwidth utilization cost, and so forth). The decision can be made in a user context by itself or in combination with other contexts, such as a distribution flow context and/or a system profitability context.

In block 138, recommendations are generated for content of value to the user (e.g., optionally providing benefit spanning a broader context, such as distribution flow and system profitability). At least one implementation of the invention queues up the recommendations prior to downloading, as represented by optional process block 140. In a preferred implementation, the system is configured with a user interface providing user access to the recommendation queue, wherein they can preview and/or modify the queue entries (e.g., delete items). It is implied that human language elements are coupled to the entries of the recommendation queue to facilitate human previewing and/or modification.

Sphere can select the optimum material for download, however, one optional aspect of the invention provides for a “sub-optimal” selection so that other metrics, such as those existing at the time of downloading, may be taken into account. This is a form of value/cost analysis in which a portion of the download decision is made at the time downloading is to commence. The system is configured to acquire information about the condition of the network, servers, and/or the P2P prior to making the decision on which content element to download. By way of example, and not limitation, content listed in the recommendation queue need not be downloaded in a priority order, and can be subject to this “sub-optimal” selection. In at least one optional implementation, additional metrics are utilized as per block 142 for selecting which content element pointed to by the queue is to be downloaded at this time. In one mode of the invention, temporal conditions, such as the distribution flow or the profitability of transactions, are introduced to enhance the selection of content elements (considered to have a high probability of benefit to the user) upon which downloading is to commence.

The recommended content as given by block 144 is automatically downloaded to the user, without the user ever being required to select content for downloading. It will be noted that the system can determine and download content elements to the user without any user interaction at all, or the user can optionally elect to provide additional information to bolster the user profile, and/or to preview recommendations prior to the download process.

Availability of the recommended content is optionally communicated to the user as per block 146 according to at least one implementation of the invention. It should be appreciated that this communication of available content may take any desired form. By way of example and not limitation, when content is available for access by the user the user can be alerted such as by making an entry within a list of downloaded elements (e.g., button accessible, program guide accessible, menu accessible, and so forth), generating an audio alert, displaying a banner ad (e.g., within a desktop, border, program guide, and so forth), a trailer played, playing of a commercial segment during the playback of other media or between media segments, or combinations of the above.

Block 148 represents the optional step of unlocking downloaded recommended content, for example in response to processing of a transaction. It should be recognized that the transaction may involve direct monetary transactions, or a pseudo-monetary transaction (e.g., media credits, vouchers, discounts, points, and so forth), or a security/identification process wherein the content can only be access by a selected party or parties, as well as other unlocking configurations and combinations thereof. It should also be recognized that certain content, such as public domain content, can be accessed by the user without the need to execute any form of transaction.

At block 150 user access of the content is represented, such as viewing of the downloaded content, or otherwise accessing the file(s) for preview, movement, deletion and so forth.

An optional feedback step is shown in block 152 in which information is collected from the user about the recommendation, while at optional step 154 the recommendation engine and/or user profile (e.g., including group lists as applicable) are modified by the system to increase future accuracy of recommendation. For example information is collected from the user on the fitness of the recommendation, such as in response to checkbox selection, menu traversal, text line parsing, or other feedback collection mechanisms. It will be appreciated that the above steps are by way of example implementation and can be utilized in combination with variations and aspects such as those described below, without departing from the teachings of the present invention.

The following list includes a number of important aspects of the Sphere system as described throughout the specification, this summary is provided by way of example and not limitation, wherein it does not list every element that would be important in any given context.

9.2 Platform Configuration.

(a) Preferably use of Sphere entails a registration process and agreement.

(b) Transaction processing enabled between users and Sphere as well as any third party involvement.

(c) Programs operating from PC systems (or similar OS based platforms) or from embedded systems.

(d) Distribution partners may be involved to provide support or ancillary services.

(e) Advertising supported on Sphere from various partners.

9.3 Preloading of Content.

(a) System build process is configured according to the invention so that a set of media content is loaded on machines when being built. Also described is the use of segmenting content and loading different segments on different machines that are configured for P2P operation. Furthermore, personalization of content delivery is described which can provide a mechanism for initializing the recommendation engine.

(b) Simulator for determining: (1) optimal number of movies to be pre-populated; (2) optimal number of segments to be used as seeds for each movie; and (3) optimal size of the segments.

9.4 Recommendation Engine.

(a) Configured to identify at least one piece of content that the user is or has a high probability of being interested.

(b) Information about available content is retained for example in the form of metadata, extracted information, rating and information collected from viewer, information from other sources, and combinations thereof.

(c) Recommendation engine operates from user preference information

(viewer profile) stored locally or on a server (e.g., central server).

(d) Identification of episodic viewing (e.g., episodes within a series). Example: series name, title, date, time, and so forth.

(e) Establishing threshold conditions for identification. Example: airing time considered as viewed or as interested.

(f) Identification of viewing based on characteristics (e.g., metadata). Example 1: classification, subject, director, actors, and so forth. Example 2: Sports (event, team, players); News (location, scope, depth, topic); Weather (location, scope, depth) and so forth.

(g) Collecting of user preferences in response to settings established for recording broadcast, cable, or satellite content (e.g., program guide).

(h) Collecting of user preferences in response to the playback of removable media content, such as from DVD, and HD content media (e.g., Blu-ray).

(i) User defined preference categories solicited and accepted.

(j) Allowing the user to mark which media content has been previously viewed and for which they have no interest, and optionally selecting specific episodes from series content lists as not being of interest.

(k) Allowing the user to mark which media content for which they are interested, and optionally select specific episodes from series content lists as being of interest.

(l) User history analyzed (e.g., viewing, indications of interest, ordering).

(m) Recommendations selected in response to maximizing value to cost ratio, or a return on investment (ROI). Ratio of cost with respect to anticipated benefit is analyzed toward providing highly cost effective selections.

(n) Recommendation engine operating from a user preference information set to select advertising and offers to be brought to the attention of the user.

(o) Recommendation engine can direct how and when advertising is played, such as played at select positions within other content (e.g., seemingly embedded), at intervals, external to the content and so forth.

(p) Recommendation engine allowing ongoing user control of how and which offers are to be directed to the user.

(q) Recommendation engine allowing user input of recent purchase interests, or reprioritizing of an ongoing list of purchase interests.

(r) Ongoing recommendation generation into a recommended content queue, which the user is allowed to access while awaiting download.

(s) Inclusion of human-readable fields within (or associated with) the records of the content queue, wherein the user can discern content information in previewing recommended content slated for download.

(t) Interfacing with the user to preview the recommended content queue, and to enter changes including deletions and changes in priority, and other changes to the elements in the content queue as desired.

(u) Control of recommended content queue depth to adjust the time period over which the user can preview recommendations before downloading is performed.

(v) Collecting user feedback on content recommendations in response to providing a reduced quality format of that content (e.g., limited resolution).

(w) Generation of human-readable reasoning as to why recommendation has been put forth.

(x) Generation of recommendation feedback based on metadata information, used to create affirmative and negative response about recommendation.

9.5 Content Distribution.

(a) Content distribution via content-distribution network (CDN) or peer-to-peer (P2P).

(b) System is capable of selecting which distribution mechanism to utilize, or combination of mechanisms, to control costs and latency factors.

(c) User selection of disk space allotment for recommended content.

(d) Distribution via server-to-peer (server-based) and Peer-to-peer (P2P).

(e) Support any mainstream CODEC and DRM.

(f) Distribution of content in response to recommendations from recommendation engine.

(g) “Trickle-down” distribution of content in a non-real-time manner.

(h) Distribution of content during periods of low bandwidth usage (e.g., such as at night, or other time period based on utilization and/or user selection).

(i) Automatic downloading of music files, such as in response to user selected type (i.e., new in genre/category/artist, recommendations.

(j) Generating incentives for supporting P2P content distribution; such as based on level of support provided.

(k) Incentives for supporting P2P in form of ability to access content, buy content, and/or rent content. Less preferably the use of direct monetary incentives.

(l) Output of human-readable reasoning for recommendation.

(m) Communication to user about fees and/or conditions associated with the viewing of the content downloaded from recommendation engine.

(n) Conditional viewing of content, in which a viewer may be allowed to view one form of content in exchange for their viewing of another piece of content, such as another show, or more typically advertising content.

(o) Gathering specific feedback as to why a recommendation is on target, or is not on target, toward enhancing recommendation accuracy for each given user

(p) Distribution through servers, from peers (e.g., in a P2P network), or a combination thereof, in response to status of the network and the utilization and cost factors.

(q) Integration with physical delivery of content. In some instances, the user may elect to obtain media in a physical format as facilitated by the system.

9.6 Storage, Management and Use of Content.

(a) Intelligent monitoring for replenishing and repositioning recommended content.

(b) Retaining recommended content for rental or sales level accessibility.

(c) Execute transaction to purchase/rent content, such as accept payment, download additional material/license material, issue license, and so forth.

(d) Automatic aggregation and synchronization of content (video, audio and images) can be performed.

(e) Playback of music library contents locally through any selected device (e.g., audio system, TV).

(f) Sharing of photos, accessible from any location.

9.7 User Interface.

(a) Link user scenarios: “2 foot” UI scenario and “10 foot” UI scenario. 2 foot is user at a PC or smart device, 10 foot is user at TV or similar.

(b) Configured for use of free-space pointing device to aid immersive user experience.

(c) Remote control optionally configured with a preference control allowing user control modification of selection input.

(d) Displaying information about recommended content.

(e) Allowing the user to preview content recommendations, to prioritize, delete and modify prior to downloading of content.

(f) Displaying which content has been received and is ready for access, such as for rental or sale.

(g) In one instance downloaded recommended content is listed in response to a remote control command, such as preferably from a single control input.

Accordingly, it will be seen that the Sphere system provides a media-centric environment from which the user is given full control of their media related experience. The system is configured to directly provide a wide range of services and to integrate with, and/or be seamlessly coupled with third party services.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for obtaining media content, comprising:
a user control server configured for communicating over a distributed network with a personal media device and for accessing media content and metadata over the distributed network;
said user control server is configured for providing selective access of media content for the personal media device which is configured for accessing and playing back content from sources coupled to the personal media device and from sources coupled through said user control server; and
a recommendation engine operably coupled to said user control server, said recommendation engine is configured for,
collecting a history of media selection and viewing for at least one user of the personal media device, said history being collected into a user media profile,
generating a recommendation for content expected to be of value to the user in response to analyzing said user media profile with respect to the media content which is accessible to said user control server,
controlling content downloading to the personal media device in response to said recommendation, said downloading performed automatically without necessitating user selection and triggering of said downloading, and
communicating to the user an availability of recommended content within the personal media device.

2. An apparatus as recited in claim 1:
wherein said distributed network comprises the Internet;
wherein at least one server provides access to the media content and metadata to said user control server.

3. An apparatus as recited in claim 1, wherein said recommendation engine comprises programming configured for execution on said control server, the personal media device, or a combination of said control server and the personal media device.

4. An apparatus as recited in claim 1, wherein the personal media device is selected from the group of electronic devices consisting of: personal computers, laptop computers, palmtops, tablet PCs, personal digital assistants (PDAs), smart phones, television sets, set-top boxes, and media recording and playback devices.

5. An apparatus as recited in claim 1, wherein said content is downloaded by the personal media device, as selected by said user control server, during periods of low bandwidth usage.

6. An apparatus as recited in claim 1, wherein said recommendation engine analyzes said user media profile with respect to the media content which is accessible to the control server.

7. An apparatus as recited in claim 1, wherein said history of media selection and viewing comprises a listing of content which has been viewed by the user.

8. An apparatus as recited in claim 7, wherein said listing of viewed content is determined in response to detecting content received by the personal media device from broadcast, cable, satellite, removable media sources, downloads or from said control server.

9. An apparatus as recited in claim 7, wherein said listing of viewed content is configured to accept user entry about content which has been previously viewed.

10. An apparatus as recited in claim 1, wherein said recommendation engine is configured for determining whether a user has viewed select content elements in response to detecting if at least one viewing threshold, based on absolute time or percentage of content, has been reached.

11. An apparatus as recited in claim 1, wherein said analyzing with respect to the media content comprises comparing characteristics detected in the user media profile with respect to a set of metadata information collected for the content which is accessible to the control server.

12. An apparatus as recited in claim 11, wherein said metadata information comprises fields selected from the group of media information fields consisting of: format type, title, genre, playing time, and keywords.

13. An apparatus as recited in claim 1:
wherein said recommendation engine is further configured for registering episodic viewing in response to user viewing of one or more episodes of a multi-episode series; and
wherein said recommendation engine is configured to consider other episodes of the multi-episode series and related content when generating content recommendations.

14. An apparatus as recited in claim 1, wherein said recommendation engine is further configured for collecting user input to direct the generating of said recommendations.

15. An apparatus as recited in claim 1, wherein said recommendation engine is further configured for outputting human-readable reasoning indicative of why a recommendation has been generated.

16. An apparatus as recited in claim 1:
wherein content recommendations are placed in a recommended content queue associated with said recommendation engine while they await downloading to the personal media device; and
wherein said content queue is configured for allowing the user to delete recommendations which have not yet been downloaded.

17. An apparatus as recited in claim 1, wherein said recommendation engine is further configured for collecting user feedback on the appropriateness of said content recommendation.

18. An apparatus as recited in claim 1, wherein the recommendation engine is further configured for:
generating a recommendation for advertising content expected to be of value to the user in response to analyzing said user media profile, which includes user set parameters regarding the conditions under which to accept advertising, and with respect to metadata about advertising content which is accessible to the control server; and
downloading advertising content to said personal media device in response to said recommendation, said download performed automatically without necessitating user triggering of said downloading.

19. An apparatus as recited in claim 1:
wherein recommendations are selected for downloading which are sub-optimal with respect to a user context, while providing benefit across a context range that exceeds the user context; and
wherein recommendations are generated with respect to one or more contexts selected from the group of contexts consisting of user context, distribution channel context, profitability context, and combinations thereof.

20. An apparatus as recited in claim 1, wherein recommendations are generated based on multiple decision points.

21. An apparatus as recited in claim 1, wherein recommendations are generated in response to a first stage which selects and queues up possible content based on non-temporal metrics, and a second stage which selects elements from the queue for downloading in response to temporal metrics and network conditions.

22. An apparatus as recited in claim 1, further comprising establishing at least one group of users whose content selection preferences are utilized as a basis for recommending content by said recommendation engine.

23. An apparatus as recited in claim 22, wherein the number of members listed in said at least one group of users is established in response to user and group member characteristics, and is not based on a fixed list size.

24. An apparatus for obtaining media content, comprising:
a personal media device configured for communicating over a distributed network with a control server configured for accessing media content and metadata over the distributed network;
said personal media device configured for accessing and playing back content from sources coupled to said personal media device and from sources coupled through said control server; and
a recommendation engine configured for,
collecting a history of media selection and viewing for at least one user of said personal media device, said history being collected into a user media profile,
generating a recommendation for content expected to be of value to the user in response to analyzing said user media profile with respect to the media content which is accessible to the control server,
downloading content to said personal media device in response to said recommendation, said download performed automatically without necessitating user triggering of said downloading, and
communicating availability of recommended content within said personal media device to the user.

25. An apparatus as recited in claim 24:
wherein recommendations are selected for downloading which are sub-optimal with respect to a user context, while providing benefit across a context range that exceeds the user context; and
wherein recommendations are generated with respect to one or more contexts selected from the group of contexts consisting of user context, distribution channel context, profitability context, and combinations thereof.

26. An apparatus as recited in claim 24, further comprising establishing at least one group of users whose content selection preferences are utilized as a basis for recommending content by said recommendation engine.

27. A method of distributing media content, comprising:
registering media viewing by a user on a personal media device, and storing registered media viewing within a media profile;
communicating between the personal media device and a control server configured for accessing media content and metadata over a distributed network;
recommending at least one media content element for download to the user in response to analyzing said media profile with respect to the available media content and the metadata; and
automatically downloading said media content element to the personal media device.

28. A method as recited in claim 27, further comprising collecting user preferences for media content selection within said media profile.

29. A method as recited in claim 27, further comprising alerting the user of the personal media device of the availability of said media content element.

30. A method as recited in claim 27, further comprising obtaining feedback from the user about the value of the downloaded recommendations.

31. A method as recited in claim 27, wherein said media content element is selected from the group of media content elements consisting of movies and shows.

32. A method as recited in claim 27, wherein said media content comprises advertising media content elements.

33. A method as recited in claim 27, further comprising:
storing a desired number of recommendations within a recommended content queue prior to downloading of the associated content;
wherein the entries within said recommended content queue can be edited by the user prior to downloading of the associated content.

34. A method as recited in claim 33, wherein each recommended content queue entry includes human-readable information about said media content element.

35. A method as recited in claim 33, further comprising obtaining feedback from the user about the value of the recommendations in the recommended content queue, wherein the media profile is changed to reflect user input.

36. A method as recited in claim 27, wherein said automatic downloading of media content is transferred to said personal media device from a server, or through a peer-to-peer network in response to analyzing user preferences and the availability of content on the peer-to-peer network.

37. A method as recited in claim 27, wherein said distributed network comprises the Internet.

38. A method as recited in claim 27, wherein the process of recommending media content is performed by programming which executes on the control server, the personal media device, or a combination of the control server and the personal media device.

39. A method as recited in claim 27, wherein said personal media device is selected from the group of electronic devices consisting of: personal computers, laptop computers, palmtops, tablet PCs, personal digital assistants (PDAs), smart phones, television sets, set-top boxes, and media recording and playback devices.

40. A method as recited in claim 27, wherein said content is downloaded by said personal media device during periods of low bandwidth usage.

41. A method as recited in claim 27, wherein the process of recommending media content comprises analyzing said media profile with respect to metadata collected for media content which is accessible to the control server.

42. A method as recited in claim 27, wherein said media profile is collected in response to detecting user activity with regard to content received by the personal media device from broadcast, cable, satellite, removable media sources, downloads or from the control server.

43. A method as recited in claim 27, further comprising obtaining information from the user about media content which has been previously obtained or viewed.

44. A method as recited in claim 27:
wherein the process of recommending media content is further configured for registering episodic viewing in response to user viewing of one or more episodes of a multi-episode series; and
wherein said process of recommending media content is configured to consider other episodes of the multi-episode series and related content when generating content recommendations.

45. A method as recited in claim 27, wherein the process of recommending media content is configured for collecting user preferences on desired media content to direct the generating of recommendations.

46. A method as recited in claim 27, wherein the process of recommending media content is configured for generating human-readable reasoning as to why a recommendation has arisen.

47. A method of distributing media content, comprising:
registering media viewed on a personal media device by a user and storing registered media viewing within a media profile;
communicating between the personal media device and a control server configured for accessing media content and metadata over a distributed network;
recommending at least one media content element for download to the user in response to analyzing said media profile with respect to metadata collected for media content which is accessible to the control server;
storing a desired number of recommendation entries within a recommended content queue which is configured for being edited by the user; and
automatically downloading said media content element to the personal media device.

48. A method as recited in claim 47, wherein said automatic downloading of media content is transferred to said personal media device from a server connected on the distributed network, or through a peer-to-peer network within the distributed network in response to analyzing user preferences and the availability of content on the peer-to-peer network.
